(19) United States
(12) Patent Application Publication
(10) Pub. No.: US 2011/0067799 A1
(43) Pub. Date: Mar. 24, 2011

(54) ADHESIVE TAPE

(75) Inventors: Bernhard Müssig, Seevetal (DE); Dennis Seitzer, Hamburg (DE); Klaus Külper, Pinneberg (DE); Nicole Behrens, Munchen (DE)

(73) Assignee: TESA SE, Hamburg (DE)

(21) Appl. No.: 12/988,612

(22) PCT Filed: Apr. 30, 2009
(86) PCT No.: PCT/EP2009/055275

§ 371 Date: Nov. 24, 2010

(30) Foreign Application Priority Data
Apr. 30, 2008 (DE) 102008021739.5
Apr. 30, 2008 (DE) 102008021741.7
Apr. 30, 2008 (DE) 102008021742.5
Apr. 30, 2008 (DE) 102008021743.3
Apr. 30, 2008 (DE) 102008021744.1
May 30, 2008 (DE) 102008025979.9
May 30, 2008 (DE) 102008025980.2
May 30, 2008 (DE) 102008025982.9
May 30, 2008 (DE) 102008025984.5

(51) Int. Cl. B32B 7/14; B32B 38/04; B32B 37/12

(52) U.S. Cl. 156/94; 156/258; 156/299; 156/324; 156/334; 428/355 EN; 428/355 BL

(57) ABSTRACT

An adhesive tape has a carrier and an adhesive that is applied to at least one side of the carrier. The adhesive is made of a tackifier resin and an olefin polymer having a density of between 0.86 and 0.89 g/cm³ and a minimum crystallite melting point of at least 105° C.

The invention relates to an adhesive tape and to its use.

Adhesive tapes are commonly manufactured with adhesives based on natural rubber, styrene block copolymer or acrylate.

Rubber adhesives are commonly composed of an elastomer, a tackifier resin, a plasticizer, and a phenolic antioxidant. The most frequent elastomer is natural rubber, and the most usual synthetic elastomers are styrene-diene block copolymers, more particularly styrene-isoprene-styrene block copolymers. A generally used plasticizer is a mineral oil, usually a white oil or, less often, an aromatic oil. For certain applications, such oils are undesirable, as for example for surface protection products (ghosting on the finish following removal), for the motor vehicle interior segment (fogging) or in paper adhesive tapes (grease strikethrough of the paper carrier after storage), and in these cases a liquid resin or plasticizer resin is used which has a melting point of 10° C. to 40° C. and which represents the most expensive component of the formulation.

The aging resistance and UV resistance of rubber adhesives are relatively low, and the compatibility of these adhesives with wire insulations is poor. Hydrogenated styrene-diene block copolymers provide a remedy here, but are extremely expensive and attain only relatively low bond strengths.

The natural rubber adhesives contain solvent and have low aging stability and UV stability.

Styrene block copolymer adhesives, generally based on styrene-isoprene-styrene block copolymers, can be processed solventlessly, but likewise have low aging stability and UV stability. Moreover, they are very hard, and so these adhesive tapes can be processed only with a loud unwind noise.

Acrylate adhesives are dispersions and hence are solvent-free and have good aging stability and UV stability, but exhibit increased sensitivity to water, and particularly a weak initial adhesion (tack) in the case of bonds to card or paper, and also poor adhesion on nonpolar substrates. For many permanent applications, therefore, they are unsuitable. They cannot be removed from very polar substrates such as aluminum or PVC, and are therefore unsuitable for such masking applications. Acrylate adhesives are not favorably priced.

There has for a long time been a desire for an adhesive which combines the positive properties of all of these adhesives with one another:

absence of solvent, water resistance, high initial adhesion, high adhesion to low-energy surfaces, unwind characteristics and redetachability like those of natural rubber adhesives, and aging stability and UV stability like those of acrylate adhesives.

It is an object of the invention to provide an adhesive tape having an adhesive of this kind.

This object is achieved by means of an adhesive tape as recorded in the main claim. Advantageous developments of the subject matter of the invention and also uses of the adhesive tape are found in the dependent claims.

The invention accordingly provides an adhesive tape comprising a carrier and an adhesive which is coated at least one-sidedly thereon and comprises an olefin polymer having a density of between 0.86 and 0.89 g/cm³ and a crystalline melting point of at least 105° C., and comprises a tackifier resin.

The skilled person considered olefin polymers to be unsuitable for adhesives for reasons including the hardness or low melting point of the raw materials. In spite of these prejudices, it is possible, surprisingly, to use olefin polymers having a density of between 0.86 and 0.89 g/cm³, preferably between 0.86 and 0.88 g/cm³, more preferably between 0.86 and 0.87 g/cm³, and having a crystallite melting point of at least 105° C., preferably at least 115° C., more preferably at least 135° C., to prepare adhesives for adhesive tapes having outstanding adhesive properties—for example, high bond strength, high tack, and high shear strength.

The olefin polymer of the invention preferably has a melt index of less than 8 g/10 min, more preferably less than 1.5 g/10 min. The flexural modulus of the olefin polymer is preferably less than 50 MPa, more preferably less than 26 MPa, and very preferably less than 17 MPa.

The olefin polymer is for example a polypropylene resin and can be constructed in a variety of ways—for example, as a block copolymer, as a graft polymer or as a so-called reactor blend as in the case of heterophasic polypropylenes (also called impact polypropylene or (not entirely correctly, but commonly) polypropylene block copolymer). The preferred polypropylene resin is preferably not a conventional, non-heterophasic random polypropylene copolymer, comprising the monomers propylene and the other olefin (ethylene or butene, for example) in random distribution, since these polymers are able to achieve only low shear strengths, bond strengths, and heat resistances. A heterophasic polypropylene, however, may comprise small amounts of a comonomer in the crystalline component, as long as the crystallite melting point is still within the range according to the invention.

The olefin polymer comprises preferably ethylene or propylene and at least one further comonomer selected from the C₂ to C₁₀ olefins, preferably C₂ to C₁₀ α-olefins. Particular suitability is possessed by copolymers of ethylene and propylene, of ethylene and but-1-ene, of ethylene and oct-1-ene, of propylene and but-1-ene, or by a terpolymer of ethylene, propylene, and but-1-ene.

The density of the polypropylene or polyethylene is determined in accordance with ISO 1183 and expressed in g/cm³. The melt index is tested in accordance with ISO 1133 with 2.16 kg and is expressed in g/10 min. The test temperature, as is familiar to the skilled person, is 230° C. for propylene-based polyolefins and 190° C. for ethylene-based polymers.

The flexural modulus can be determined in accordance with ASTM D 790 (Secant modulus at 2% strain).

The crystallite melting point (T_{cr}) and the heat of fusion are determined by DSC (Mettler DSC 822) with a heating rate of 10° C./min in accordance with ISO 3146; where two or more melting peaks occur, the peak selected is that having the highest temperature, since only melting peaks above 100° C. are retained in adhesive formulations and are effective, whereas melting peaks considerably below 100° C. are not retained and have no effect on the product properties. The heat of fusion determines first the bond strength and the tack of the formulation and secondly the shear strength especially under hot conditions (that is, 70° C. and above).

The heat of fusion of the olefin resin is therefore important for the optimum compromise in the adhesive properties, and is preferably between 3 and 18 J/g, more preferably between 5 and 15 J/g.

The heat of fusion of the adhesive likewise plays a part for the optimum compromise in the adhesive properties, and is preferably between 1 and 6 J/g, more preferably between 2 and 5 J/g.

The olefin polymer of the invention can be combined with elastomers such as natural rubber or synthetic rubbers. It is preferred to use unsaturated elastomers such as natural rubber, SBR, NBR or unsaturated styrene block copolymers only in small amounts or more preferably not at all. Synthetic rubbers with saturation in the main chain, such as polyisobutylene, butyl rubber, EPM, HNBR, EPDM or hydrogenated styrene block copolymers, are preferred in the event of a desired modification.

It has emerged that the olefin polymer of the adhesive is able to accommodate considerable amounts (more than 100 phr) of tackifier resin and hence to attain a very good adhesive behavior. The polydispersity is the ratio of weight average to number average of the molar mass distribution and can be determined by gel permeation chromatography; it plays an important part with regard to the properties. Tackifier resins used are therefore those having a polydispersity of less than 2.1, preferably less than 1.8, more preferably less than 1.6. The highest tack is attainable with resins having a polydispersity of 1.0 to 1.4.

As tackifier resin it has been found that resins based on rosin (for example, balsam resin) or on rosin derivatives (for example, disproportionated, dimerized or esterified rosin), unhydrogenated, partially or completely hydrogenated, are highly suitable. Of all tackifier resins they have the highest tack. This is presumably due to the low polydispersity of 1.0 to 1.2. Terpene-phenolic resins, like the hydrogenated resins, are notable for particularly high aging stability.

Preference is likewise given to hydrocarbon resins, whose compatibility is good, presumably on account of their polarity. These resins are, for example, aromatic resins such as coumarone-indene resins or resins based on styrene or α-methylstyrene, or cycloaliphatic hydrocarbon resins from the polymerization of C₅ monomers, such as piperylene, or C₅ or C₉ fractions from crackers, or terpenes such as β-pinene or δ-limonene, or combinations hereof, preferably partially or completely hydrogenated, and hydrocarbon resins obtained by hydrogenating aromatics-containing hydrocarbon resins, or cyclopentadiene polymers.

Additionally it is possible for resins based on polyterpenes, preferably partially or completely hydrogenated, and/or terpene-phenolic resins to be used.

The amount of tackifier resin is preferably 130 to 350 phr, more preferably 200 to 240 phr (phr denotes parts by weight relative to 100 parts by weight of resin or rubber, which in this case means olefin polymer).

In order to adjust the desired properties, the adhesive preferably comprises a liquid plasticizer such as, for example, aliphatic (paraffinic or branched) and cycloaliphatic (naphthenic) mineral oils, esters of phthalic, trimellitic, citric or adipic acid, waxes such as wool wax, liquid rubbers (for example, low molecular mass nitrile rubbers, butadiene rubbers or polyisoprene rubbers), liquid polymers of isobutene homopolymer and/or isobutene-butene copolymer, liquid resins and plasticizer resins having a melting point of below 40° C. and based on the raw materials of tackifier resins, particularly the classes of tackifier resin listed above.

Particular preference among these is given to liquid polymers of isobutene and/or butene and esters of phthalic, trimellitic, citric or adipic acid, more particularly their esters with branched octanols and nonanols.

Instead of a liquid plasticizer it is also possible for a very soft olefin polymer of virtually no crystallinity to be used. This polymer is preferably a copolymer of ethylene, propylene, but-1-ene, hex-1-ene and/or oct-1-ene, which are known, for example, under the trade names Exact®, Engage®, Versify® or Tafmer®, or a terpolymer of ethylene, propylene, but-1-ene, hex-1-ene and/or oct-1-ene, the flexural modulus being preferably below 10 MPa and the crystallite melting point being preferably below 50° C.

Other preferred olefin polymers are optionally oil-free EPM or EPDM, in other words copolymers or terpolymers of ethylene and propylene and, optionally, a diene such as ethylidenenorbornene, preferably having an ethylene content of 40% to 70% by weight, a Mooney viscosity (conditions 1+4, 125° C.) of below 50 and/or a density of below 0.88 g/cm³, more preferably below 0.87 g/cm³. Since such ethylene polymers are indeed very soft, as compared with a liquid plasticizer, the amount in relation to the olefin polymer of the invention ought to be very high, in other words well above 100 phr.

The melting point of the tackifier resin (determination in accordance with DIN ISO 4625) is likewise important. The bond strength of a rubber composition (based on natural rubber or synthetic rubber) typically rises in line with the melting point of the tackifier resin. In the case of the olefin polymer of the invention, the behavior appears to be the opposite. Tackifier resins with a high melting point of 115° C. to 140° C. are significantly less favorable than those with a melting point below 105° C., which are preferred. Resins having a melting point of below 85° C. are not widely available commercially, since the flakes or pellets cake together in transit and in storage.

In accordance with the invention, therefore, it is preferred to combine a common tackifier resin (having, for example, a melting point from the range 85° C. to 105° C.) with a plasticizer in order to achieve a de facto reduction in the resin melting point. The mixed melting point is determined on a homogenized mixture of tackifier resin and plasticizer, the proportion between the two components being the same as that present in the adhesive. The mixed melting point is preferably in the range from 45° C. to 95° C.

Conventional adhesives based on natural rubber or unsaturated styrene block copolymers as their elastomer component typically comprise a phenolic antioxidant in order to prevent the oxidative degradation of this elastomer component with double bonds in the polymer chain.

The adhesive of the invention, however, comprises an olefin polymer without oxidation-sensitive double bonds, and there is therefore no need for an antioxidant.

In order to optimize the properties, the self-adhesive employed can be blended with further additives such as even primary or secondary antioxidants, fillers, flame retardants, pigments, UV absorbers, antiozonants, antioxidants, metal deactivators, light stabilizers such as HALS, flame initiators, photoinitiators, crosslinking agents or crosslinking promoters. Examples of suitable fillers and pigments are microballoons, zinc oxide, titanium dioxide, carbon black, titanium dioxide, calcium carbonate, zinc carbonate, zinc oxide, silicates or silica.

Microballoons are elastic hollow spheres which have a thermoplastic polymer shell. These spheres are filled with low-boiling liquids or liquefied gas. Shell materials used include, in particular, polyacrylonitrile, PVDC, PVC or polyacrylates. As a low-boiling liquid, hydrocarbons of the lower alkanes, such as isobutane or isopentane, for example, are particularly suitable, and are included in the form of a liquefied gas under pressure in the polymer shell.

Exposure of the microballoons, especially thermal exposure, has the effect first of softening the outer polymer shell. At the same time, the liquid propellant gas located in the shell is converted to its gaseous state. The microballoons expand irreversibly and three-dimensionally. Expansion is at end when the internal pressure matches the external pressure. Since the polymeric shell remains intact, a closed-cell foam is obtained accordingly.

A large number of types of microballoon are available commercially, such as, for example, from Akzo Nobel, the Expancel DU (dry unexpanded) grades, which differ essentially in their size (6 to 45 μm in diameter in the unexpanded state) and the initiation temperature they require for expansion (75° C. to 220° C.). If the type of microballoon and the foaming temperature are harmonized with the machine parameters and with the temperature profile required for compounding the composition, then compounding of the composition and foaming may also take place simultaneously in one step.

Furthermore, unexpanded microballoon grades are also obtainable in the form of an aqueous dispersion having a solids fraction or microballoon fraction of approximately 40% to 45% by weight, and are additionally available as polymer-bonded microballoons (masterbatches), as for example in ethyl vinyl acetate with a microballoon concentration of approximately 65% by weight.

The adhesive, according to one preferred embodiment, comprises
a primary antioxidant, preferably in an amount of at least 2, more preferably at least 6, phr and/or with a sterically hindered phenolic group, and/or
a secondary antioxidant in an amount of 0 to 5, preferably in an amount of 0.5 to 1, phr and/or from the class of the sulfur compounds or the class of the phosphites.

The adhesive of the invention may comprise absorbent fillers such as, for example, cellulose derivatives such as carboxymethylcellulose, pectin, gelatin, polyvinyl alcohol, polyvinyl acetate, polyethylene oxide, polyvinylpyrrolidone, collagen, alginate in the form of hydrocolloids or hydrogels, more particularly in view of the skin bonding utility described later on.

The adhesive of the invention may further comprise antimicrobial additives such as, for example, additives based on silver salts, iodine, chloramine, chlorhexidine or zinc salts, in order to obtain a germicidal activity and in order to prevent infections, again in particular with a view to the skin bonding utility described later on.

In one particularly advantageous embodiment the adhesive tape has a carrier and has a substantially mineral oil-free adhesive, coated onto the carrier from the melt single-sidedly at least, comprising an ethylene polymer having a density of between 0.86 and 0.89 g/cm³ and a crystallite melting point of at least 105° C., and comprising a tackifier resin. Mineral oil plasticizer is omitted.

Mineral oils, although very good for producing tack in the ethylene polymer of the invention, are too volatile to achieve good fogging values (DIN 75201), i.e., for example, >60, or in order to prevent ghosting (residues in masking tapes and surface protection tapes) or grease strikethrough of paper carriers on hot storage of the rolls. Consequently, the adhesive is substantially free from mineral oils.

The pressure-sensitive adhesive is stable to aging and is UV-stable. With this adhesive, the adhesion for polar and nonpolar substrates is adjustable, and the solvent is also solventlessly processable.

As compared with similar adhesive tapes based on natural rubber or unsaturated styrene block copolymers, the adhesive tape has advantages not only in its cable compatibility but also in its compatibility with corrugated tubes of polypropylene and polyamide, of the kind customary in cable looms in automobile construction.

The ethylene polymer preferably has a melt index of less than 6 g/10 min, more preferably less than 1.5 g/10 min. The flexural modulus of the ethylene polymer is preferably less than 26 MPa, more preferably less than 17 MPa. The ethylene polymer preferably comprises a C₃ to C₁₀ olefin, more particularly 1-octene, as comonomer. The ethylene polymer preferably has a structure comprising crystalline polyethylene blocks and substantially amorphous blocks of ethylene and a C₃ to C₁₀ olefin.

Conventional adhesive tapes with a textile carrier or paper carrier have a tendency when stored on the one hand to undergo deformation (formation of noses and hollow points) and on the other hand, as a result of cold flow of the adhesive, there is a continual increase in the unwind forces, until unwinding becomes too difficult for the user or else the adhesive or the paper carrier splits open in an unwind test. A further surprising advantage, therefore, is the storage stability of the adhesive tape rolls of the invention. Even after one month of storage at 70° C., the subject matter of the invention retains good unwindability, and the paper carrier does not suffer grease strikethrough as a result of oil migration. Masking tapes for painting, or surface protection tapes, can be removed without residue even after a number of weeks of outdoor weathering.

As tackifier resins, resins based on rosin (balsam resin, for example) or rosin derivatives (for example, disproportionated, dimerized or esterified rosin), preferably partially or completely hydrogenated, have proven well suitable.

The adhesive preferably comprises a liquid, mineral oil-free plasticizer, of the kind comprehensively described.

Conventional adhesives based on natural rubber or unsaturated styrene block copolymers as elastomer component typically comprise a phenolic antioxidant in order to prevent oxidative degradation of this elastomer component with double bonds in the polymer chain. The adhesive of the invention, however, comprises an ethylene polymer without oxidation-sensitive double bonds, and ought therefore to manage without an antioxidant. Surprisingly it has been found that antioxidants enhance the compatibility of the adhesive with the wire insulations. It is therefore preferred to use a primary antioxidant and with particular preference a secondary antioxidant as well.

The level of application of adhesive (coating thickness) in this embodiment is preferably between 10 and 120 g/m², more preferably between 20 and 70 g/m².

The inventive embodiment of the adhesive tape with a carrier and with an adhesive which is coated onto the carrier from the melt one-sidedly at least and comprises an ethylene polymer having a density of between 0.86 and 0.89 g/cm³ and a crystallite melting point of at least 105° C., and comprises a tackifier resin, is suitable with particular advantage for bonding on low-energy surfaces, more particularly for bonding on substrates comprising nonpolar paints or olefin polymers, with particular preference for closing or strapping polyolefin bags, or for fixing parts made of olefinic plastics or elastomers, more particularly for fixing parts in motor vehicles.

Adhesive tapes for the bonding of low-energy surfaces are typically manufactured with adhesives based on natural rubber, styrene block copolymer, and acrylate. Both kinds of rubber compositions exhibit good adhesion on low-energy surfaces. Adhesives based on hydrogenated styrene block copolymers are very expensive and adhere poorly to other substrates. They likewise soften even well below 100° C.

Acrylate adhesives have good aging stability and UV stability, but their adhesion to nonpolar polymers, such as olefinic polymers, for example, is poor despite all of the efforts made to date; for this reason, the surfaces where bonding is to take place must be pretreated with solvent-containing primers.

Pressure-sensitive silicone adhesives have good aging stability and UV stability and good adhesion to low-energy surfaces, but are extremely expensive and cannot be lined with the typical siliconized liners (and/or cannot be peeled again from said liners). The adhesive of the invention is solventless, exhibits a high level of adhesion to low-energy surfaces, and exhibits aging stability and UV stability that are like those of acrylate adhesives.

The adhesive exhibits outstanding adhesion to a very large number of substrates, including, in particular, to low-energy surfaces such as nonpolar paints or olefin polymers.

The composition of the adhesive is guided by that described for the mineral oil-free adhesive comprising an ethylene polymer.

Preferred coating techniques for the application of the adhesive are extrusion coating with slot dies, and calender coating.

The adhesive tape of the invention, particularly in the case of its use for bonding to low-energy surfaces, is preferably double-sidedly adhesive.

In the case of multilayer construction, two or more layers may be brought one above another by coextrusion, lamination or coating. Coating may take place directly or onto a liner, or onto an in-process liner.

The pressure-sensitive adhesive may
be present on one side of a carrier, with the other side bearing a noninventive pressure-sensitive adhesive based preferably on polyacrylate, or bearing a noninventive sealing layer, or
be present on both sides of a carrier, in which case the two pressure-sensitive adhesives may have the same or different compositions.

The adhesive tape is preferably lined on one or both sides with a liner. The liner for the product or the in-process liner is, for example, a release paper or a release film, preferably with silicone coating. Carriers contemplated include, for example, films of polyester or polypropylene, or calendered papers with or without a coating of dispersion or of polyolefin.

The amount of composition applied (coating thickness) of a layer is preferably between 30 and 200 g/m², preferably between 50 and 75 g/m². The overall thickness of the adhesive tape without liner is preferably 600 to 1500 μm, more preferably 700 to 5000 μm.

Preferably at least one layer is crosslinked, with particular preference the layer according to the invention. This crosslinking may take place by means of high-energy beams, preferably electron beams, or by a peroxide crosslinking or silane crosslinking.

The adhesive tape of the invention is formed by application of the adhesive, partially or over the whole area, to preferably one side or, where appropriate, both sides of the carrier. Coating may also take place in the form of one or more stripes in the longitudinal direction (machine direction), optionally in the transverse or cross direction, but more particularly over the whole area. Furthermore, the adhesives may be applied in patterned dot format by means of screen printing, in which case the dots of adhesive may also differ in size and/or distribution, or by gravure printing of lines which join up in the longitudinal and transverse directions, or by engraved-roller printing, or by flexographic printing. The adhesive may be in the form of domes (produced by screen printing) or else in another pattern such as lattices, stripes or zigzag lines. Furthermore, for example, it may also have been applied by spraying, producing a more or less irregular pattern of application.

The pressure-sensitive adhesives may be prepared and processed from solution and also from the melt. Preferred preparation and processing methods take place from the melt. For the latter case, suitable preparation operations encompass not only batch processes but also continuous processes. Particular preference is given to the continuous manufacture of the pressure-sensitive adhesive with the aid of an extruder and subsequent coating directly onto the target substrate, with the adhesive at an appropriately high temperature. Preferred coating methods are extrusion coating with slot dies, calender coating, spray coating, and melt screen printing. Furthermore, coating may also take place on both sides of the carrier material, producing a double-sided adhesive tape.

The adhesive may be distributed uniformly over the carrier material, or alternatively, as appropriate for the function of the product, may be applied over the area with different thicknesses or closenesses.

The percentage fraction of the area that is coated with the adhesive ought to be at least 20% and can be up to 95%, for specific products preferably 40% to 60% and also 70% to 95%. This can be achieved where appropriate by multiple application, in which case, optionally, adhesives having different properties may also be used.

According to one advantageous embodiment of the invention, the adhesive tape has a bond strength to the reverse of the carrier of at least 1.5 N/cm, particularly a bond strength of between 2.5 N/cm and 5 N/cm. On other substrates, higher bond strengths may be achieved.

Depending on carrier material and its temperature sensitivity, the self-adhesive may be applied directly or may first be applied to an auxiliary support and then transferred to the ultimate carrier.

Suitable carrier materials include all rigid and elastic sheet-like structures made from synthetic and natural raw materials. Preference is given to carrier materials which following application of the adhesive can be employed in such a way that they fulfill the properties of a functionally appropriate dressing.

As carrier material it is possible to make use, for example, of textiles such as wovens, knits, scrims, nonwovens, laminates, nets, films, papers, tissues, foams, and foamed films. Suitable films are of polypropylene, preferably oriented polyester, plasticized and unplasticized PVC, preferably with a weight per unit area of less than 50 g/m² and, in the case of films, preferably less than 15 μm, so that the adhesive tape has sufficient conformability. Particularly preferred are polyolefin, polyurethane, EPDM, and chloroprene foam. By a polyolefin is meant polyethylene and polypropylene, with polyethylene being preferred on account of the softness. The term “polyethylene” includes LDPE but also ethylene copolymers such as LLDPE and EVA. Particularly suitable are crosslinked polyethylene foams or viscoelastic foams. The latter are preferably made of polyacrylate, and more preferably are filled with hollow structures of glass or polymers such as microballoons.

As carrier material it is possible to use polymeric films such as, for example, films of polyolefin such as polyethylene, polypropylene, polybutene, copolymers thereof, blends of these polymers, as for example with polyethylene-vinyl acetate, or ionomers, and also films of polyvinyl chloride or polyester. Stretchable films may be strengthened by a reinforcement, preferably a filament scrim. Also possible is the use of paper/plastic assemblies, obtained for example by extrusion coating or lamination. Depending on application, textile materials may be open-pore, or used in the form of a textile/plastic assembly as carrier material. The plastics used may comprise flame retardants such as, for example, antimony trioxide or bromine-containing flame retardants such as, for example, Saytex® 8010. The carrier material may have thicknesses of between 30 and 150 μm, preferably between 50 and 100 μm.

Before being combined with the adhesive, the carriers may be prepared (on the coating side) chemically such as by primer or by a physical pretreatment such as corona. Their reverse may have been subjected to an antiadhesive physical treatment or coating.

For double-sided adhesive tapes, crosslinked polyethylene foams are treated such that the adhesion of pressure-sensitive acrylate adhesives to them is very poor and is not very satisfactory even with a treatment, since these carriers contain lubricants such as erucamide as a consequence of the production operation.

It is therefore entirely surprising that the compositions of the invention, even without treatment, adhere outstandingly to such foams—this means that, in the event of a vigorous attempt to detach them, the foam is destroyed.

Furthermore, these materials may be pretreated and/or aftertreated. Common pretreatments are corona and hydrophobing; customary aftertreatments are calendering, heat treating, laminating, punching, and encasing.

The laminating of the carrier with at least one additional layer of textiles, foams or films has also emerged as being advantageous, since it produces a combination of properties of a particular kind. A foam has a substantially higher breathability than a nonlaminated carrier. Films may be used, for example, for the sealing of the surface.

The preparation and processing of the pressure-sensitive adhesives may take place from solution and also from the melt. The advantage of the processing of the pressure-sensitive adhesive from the melt lies in the possibility of being able to achieve very high coat thicknesses (coat weights) in a very short time, since there is no need to remove solvent after the coating operation. Preferred preparation and processing techniques are therefore from the melt. For the latter case, suitable preparation operations encompass both batch processes and continuous processes. Particularly preferred is the continuous manufacture of the pressure-sensitive adhesive by means of an extruder and subsequent coating directly onto the target substrate or a release paper or release film, with the adhesive at an appropriately high temperature. Preferred coating processes are extrusion coating with slot dies, and calender coating.

The coat weight (coating thickness) is preferably between 10 or 15 and 300 g/m², more preferably between 20 and 250 g/m², with particular preference between 70 and 160 g/m².

For use as a pressure-sensitive adhesive tape, the single- or double-sided pressure-sensitive adhesive tapes may be lined with one or two release films or release papers. In one preferred version, siliconized or fluorinated films or papers are used, such as glassine, HPDE or LDPE coated papers, for example, which in turn are provided with a release layer based on silicones or fluorinated polymers.

The general expression “adhesive tape” in the context of this invention encompasses all sheet-like structures such as two-dimensionally extended films or film sections, tapes with extended length and limited width, tape sections, diecuts, labels, and the like.

The adhesive tape may be produced in the form of a roll, in other words in the form of an Archimedean spiral wound onto itself.

In the text below, the invention is illustrated in more detail by a number of examples, without wishing thereby to restrict the invention.

Raw materials of the examples:
IN FUSE 9107: Copolymer of ethylene and oct-1-ene, melt index 1 g/10 min, density 0.866 g/cm³, flexural modulus 15.5 MPa, crystallite melting point 121° C.
IN FUSE 9507: Copolymer of ethylene and oct-1-ene, melt index 5 g/10 min, density 0.866 g/cm³, flexural modulus 13.9 MPa, crystallite melting point 119° C.
NOTIO PN-0040: Copolymer of propylene and but-1-ene (possibly with small amounts of ethylene as well), melt index 4 g/10 min, density 0.868 g/cm³, flexural modulus 42 MPa, crystallite melting point 159° C., heat of fusion 5.2 J/g
Softell CA02: Copolymer of propylene and ethylene, melt index 0.6 g/10 min, density 0.870 g/cm³, flexural modulus 20 MPa, crystallite melting point 142° C., heat of fusion 9.9 J/g
Engage 7467: Copolymer of ethylene and but-1-ene, melt index 1.2 g/10 min, density 0.862 g/cm³, flexural modulus 4 MPa, crystallite melting point 34° C.
LD 251: LDPE, melting index 8 g/10 min, density 0.9155 g/cm³, flexural modulus 180 MPa, crystallite melting point 104° C.
PB 0300 M: Polybutene, melt index 4 g/10 min, density 0.915 g/cm³, flexural modulus 450 MPa, crystallite melting point 116° C.
Buna EP G 3440: EPDM, density of 0.86 g/cm³, Mooney viscosity 28, 48% by weight ethylene, 48% by weight propylene, and 4% by weight diene
Ondina 933: White oil (paraffinic-naphthenic mineral oil)
Wingtack 10: Liquid C₅ hydrocarbon resin
Escorez 1310: Nonhydrogenated C₅ hydrocarbon resin, melting point of 94° C., polydispersity 1.5
Escorez 1102: Nonhydrogenated C₅ hydrocarbon resin with a melting point of 100° C. and a polydispersity of 2.6
Escorez 5400: Fully hydrogenated cyclopentadiene resin with a melting point of 103° C. and a polydispersity of 2.3
Wingtack extra: Aromatics-modified C₅ hydrocarbon resin, melting point 97° C., polydispersity 1.6
Regalite R1100: Hydrogenated aromatic hydrocarbon resin, melting point 100° C., polydispersity 1.9
Eastotac C 130 L: Fully hydrogenated C₅ hydrocarbon resin (in contrast to Eastotac H 130 R as a not fully hydrogenated resin with a polydispersity of 2.1), with a melting point of 130° C. and a polydispersity of 2.0
Eastotac C 115 L: Fully hydrogenated C₅ hydrocarbon resin with a melting point of 115° C. and a polydispersity of 1.9
Irganox 1726: Phenolic antioxidant with sulfur-based function of a secondary antioxidant
Irganox 1076: Phenolic antioxidant
Irganox PS 802: Sulfur-based secondary antioxidant
Oppanol B 10: Liquid polyisobutene
Foral 85: Fully hydrogenated glyceryl ester of rosin, with a melting point of 85° C. and a polydispersity of 1.2
PRO 10493: Nonhydrogenated C₅ hydrocarbon resin with a melting point of 98° C. and a polydispersity of 2.0
Tinuvin 622: HALS-based UV stabilizer
TOTM: Tris(2-ethylhexyl) trimellitate

### Test methods

Unless indicated otherwise the measurements are carried out under test conditions of 23±1° C. and 50±5% relative humidity.

The unwind force is measured at 300 mm/min in accordance with DIN EN 1944.

The aging tests are conducted in accordance with automobile standard LV 312-1 “protection systems for cable harnesses in motor vehicles, adhesive tapes; test guideline” (02/2008), a joint standard of the companies Daimler, Audi, BMW, and Volkswagen.

The bond strengths are determined at a peel angle of 180° in accordance with AFERA 4001 on test strips with a width of 15 mm. As the test substrate, steel plates according to the AFERA standard, or the reverse of the adhesive tape, are used in this test.

The determination of the bond strength in the case of the embodiment with a woven fabric carrier for exterior application is carried out along the lines of AFERA 5001, as follows. As defined substrates, a steel surface, a polyethylene surface (PE) and a 150-grade sandpaper are used. The bondable sheet-like element under investigation is cut to a width of 20 mm and to a length of approximately 25 cm, a handling section is attached, and immediately thereafter the element is pressed onto the selected substrate five times using a 4 kg steel roller, with a rate of advance of 10 m/min. Directly after that, the bonded sheet-like element is peeled from the substrate at an angle of 180° using a tensile testing instrument (from Zwick), and the force needed to achieve this at room temperature is recorded. The measurement value (in N/cm) is produced as the average from three individual measurements.

For the measurement of the UV stability (UV test), the specimens, in 20 mm width and 25 cm length, are adhered to a glass plate with a thickness of 4 mm and are rolled on five times using a 2 kg roller. The specimens are stored with the glass side upward in a UV chamber with a xenon lamp under an irradiance of 300 W/m². Each day, one new strip per example is taken from the UV chamber and, after conditioning to room temperature for 1 hour, is peeled from the glass plate.

During this procedure, the adhesion is assessed and a record is made of whether there are marked changes, tears or residues of adhesive on the glass plate.

As a weathering test in the form of an accelerated test rather than the time-consuming outdoor weathering, the so-called “Suntest” is carried out along the lines of ISO 4892-2 (2006) by method A. For this test, specimens of unplasticized PVC, glass and PE are bonded and subjected to a combination of UV irradiation by means of a 765 watt xenon lamp and to temporary irrigation. In the two-hour cycles, 18 minutes of a combination of irrigation and irradiation are followed by a period of 102 minutes of irradiation without irrigation.

After the weathering time, the strips, after reconditioning to room temperature, are assessed visually, then peeled off at 90° and 180°. According to manufacturer information (for example, from Atlas), one week of the Suntester corresponds to approximately 3 months of outdoor weathering in central Europe.

Where the peeled test strips allow, their bond strength after storage is ascertained. Long-term tests carried out sporadically under real outdoor conditions (outdoor weathering) took place in Hamburg on the same substrates, on the roof of a building facing south with a slope of 45°. The results were comparable with those from the accelerated tests stated above.

The density of the polymers is determined in accordance with ISO 1183 and expressed in g/cm³.

The crystallite melting point (T_{cr}) is determined by DSC in accordance with MTM 15902 (Basell) method) or ISO 3146.

The thickness is determined in accordance with DIN 53370, the gauge being planar (not curved). In the case of textured films, however, the thickness taken as a basis is that prior to embossing. This can also be done subsequently via the weight per unit area (determined in accordance with DIN 53352) and conversion using the density. The embossed depth is the difference between the thicknesses with and without embossing. The bond strengths to steel in the case of the embodiment for construction applications are determined with a peel angle of 180° along the lines of AFERA 4001 on (where possible) test strips with a width of 20 mm. In this case, steel plates according to the AFERA standard are used as the test substrate, and a strip of the test adhesive tape is applied to these plates. Adhesive tapes with soft carrier films, in other words adhesive tapes where the film is stretched at forces below the bond strength to steel, are reinforced with a 20 mm wide strip of Tesa® 4224 (an 83 μm adhesive tape based on a PP film with a rubber adhesive, having a bond strength of 8.25 N/25 mm). Where double-sided adhesive tapes are tested, the side that is not intended to be tested is lined with a strip of unplasticized PVC having a width of 20 mm and a thickness of 30 μm. Testing is carried out in accordance with AFERA 4001.

Bond strengths on polyethylene are determined on adhesive bonds, 20 mm wide, between a polyethylene film having a thickness of 190 μm and the adhesive tape, without storage beforehand. The film is fastened vertically downward, and the adhesive tape is peeled off vertically upward at a speed of 300 mm/min. For adhesive tapes with soft carrier films or double-sided adhesive tapes, the same approach is taken as for the determination of the bond strength to steel.

To determine the aging resistance, bonds made with the adhesive tape on commercial wind seals, vapor diffusion retarders or vapor barriers are tested. Test specimens as described in the method for determining the bond strength to polyethylene are used. Storage takes place for 20 weeks at 65±1° C. and 85±5% relative humidity.

The fogging value is determined in accordance with DIN 75201.

The tack is determined by applying a sample to kraft paper, in the same way as described for the determination of bond strength, and quickly peeling the sample. The tack is good when the paper fibers are extracted, or the paper splits, on at least 50% of the bond area.

The invention is described in more detail below by a number of examples, without any intention that these should have any restrictive effect whatsoever. For the various possible uses recognized as being advantageous, there are further examples, tailored specifically to the particular mode of use, which are likewise intended to serve only for illustration.

### EXAMPLE 1

The adhesive is composed of the following components: 100 phr in FUSE 9107, 100 phr Engage 7467, 425 phr Escorez 1310, 16 phr Irganox 1726.

The adhesive is prepared continuously in an extruder and applied at 70 g/m² to a woven polyester fabric by means of nozzle coating from the melt. The filament fabric has a basis weight of 130 g/m² comprising polyester yarn of 167 dtex with 45 threads per cm in warp direction and 25 threads per cm in weft direction. The coated bale is processed by slitting into rolls with a width of 19 mm and a running length of 10 m, the internal core diameter being 38 mm.

Bond strength to steel 5 N/cm, bond strength to reverse 2.5 N/cm.

Roll storage, 1 month at 70° C.: the roll is slightly deformed and readily unwindable.

Compatibility testing: the completed adhesive tape is wound as per LV 312 around a wire pairing with different insulating materials, and stored at the corresponding temperature. Six such test specimens are produced per insulating material. Every 500 hours, one of the specimens is inspected, the adhesive tape is unwound again, and the cable is wound around a mandrel 2 mm in diameter. Investigation is carried out to determine whether the insulation is damaged and whether the adhesive exhibits tack. Test temperatures: PVC 105° C. and on crosslinked PE at 125° C. After 3000 hours, all of the wire insulations are still undamaged. After 3000 hours at 105° C., there has been virtually no penetration of adhesive into the carrier, and the adhesive still has good tack. After 3000 hours at 125° C., the composition has undergone partial penetration into the carrier, but is still tacky.

Fogging value as per DIN 75201: 85.

### EXAMPLE 2

The adhesive is composed of the following components:

100 phr IN FUSE 9107, 100 phr Buna EP G 3440, 425 phr Regalite 1100, 8 phr Irganox 1076, and 8 phr Irganox PS 802. Coating takes place as in example 1 at 40 g/m² onto a ready-furnished paper carrier SC/042 P (Gessner, 60 g/m²).

The adhesive tape is adhered to a metal panel with 2-component PU paint, of the kind common for the automotive industry, and is subjected to outdoor weathering in Hamburg; after 4 weeks, the adhesive tape can be peeled off again without residue. After the rolls have been stored for 4 weeks at 70° C., the paper shows no grease strikethrough and the roll has suffered only slight deformation.

### EXAMPLE 3

The adhesive is composed of the following components:

100 phr IN FUSE 9107, 100 phr Buna EP G 3440, 425 phr Escorez 1310, 8 phr Irganox 1076, and 8 phr Irganox PS 802. Coating takes place as in example 1 at 68 g/m². The adhesive is applied to the following carrier: Maliwatt stitch bonded web of polyester fibers of approximately 3.4 dtex with a fiber length of approximately 80 mm, a basis weight of 72 g/m², and a fineness F 22 with a stitch length of 1 mm of a polyester yarn of 50 dtex.

Bond strength to steel 6.2 N/cm, bond strength to the reverse 2.4 N/cm.

Roll storage, 1 month at 70° C.: the roll is slightly deformed and easily unwindable.

Compatibility test on PVC at 105° C. and on crosslinked PE and PP at 125° C.:

After 3000 hours, all of the wire insulations are still undamaged. After 3000 hours at 105° C., there has been virtually no penetration of the adhesive into the carrier, and the adhesive still has a good tack. After 3000 hours at 125° C., the adhesive has undergone partial penetration into the carrier, but is still tacky.

### EXAMPLE 4

Implementation is as described in example 1, but the adhesive is composed of 100 phr IN FUSE 9507, 140 phr Oppanol B 10, 250 phr Foral 85, 8 phr Irganox 1076, and 5 phr Tinuvin 622. Coating takes place at 15 g/m² on the base layer of a carrier film. This film is composed of a 50 μm thick base layer comprising 59.7 parts by weight of PP homopolymer, 30 parts by weight of LLDPE, 10 parts by weight of inorganically coated titanium dioxide, and 0.3 part by weight of a HALS stabilizer (Tinuvin 622), and of a 15 μm thick outer layer of 30 parts by weight of PP homopolymer and 70 parts by weight of LDPE (LD 251).

The resulting product is adhered to a metal panel with 2-component PU paint, as is customary for automobiles, and is subjected to UV aging (1750 h Xenotest 150, corresponding to 97 KLY); following subsequent peel removal, there were no residues of adhesive.

### EXAMPLE 5

The adhesive is composed of the following components: 100 phr IN FUSE 9107, 100 phr Engage 7467, 425 phr Escorex 1310, 16 phr Irganox 1726.

The adhesive is prepared continuously in an extruder and applied by means of nozzle coating from the melt double-sidedly at 70 g/m² onto a 25 g/m² tissue. The product is lined with a polyethylene-coated release paper. Bond strength to steel of the open side and on the lined side is 5 N/cm in each case. The bond strength to a polypropylene sheet is in each case >10 N/cm.

The bond strengths are determined with a peel angle of 180° in accordance with AFERA 4001 on test strips having a width of 15 mm. The side not bonded to steel or polypropylene is laminated, prior to measurement of the bond strength, with an etched polyester film 25 μm thick.

### EXAMPLE 6

Production takes place in the same way as for example 5, with the adhesive being composed of the following components: 100 phr IN FUSE 9107, 212 phr Foral 85, 78 phr Ondina 933, 2 phr Irganox 1726. Coating takes place at 65 g/m² on a crosslinked polyethylene foam, Alveolith THL SR0701.

Bond strength to steel of the open side and on the lined side is 9 N/cm in each case. The bond strength to a polypropylene sheet is in each case >10 N/cm. If two plies of the product are adhered to one another, without reinforcement with the polyester film, and an attempt is made to part the bond after one minute, the foam splits.

### EXAMPLE 7

Production takes place in the same way as for example 5, the adhesive being composed of the following components: 100 phr IN FUSE 9507, 250 phr Regalite 1100, 140 phr Oppanol B 10, 2 phr Irganox 1726.

Coating takes place at 50 g/m² onto a viscoelastic polyacrylate carrier 800 μm thick. The composition and also its preparation are described in WO 2006/027389 A1 as example carrier VT1. The other side is likewise laminated with 50 g/m² of an acrylate solvent composition (corresponding to example PA 1 of WO 2006/027389 A1).

Bond strength to steel of the ethylene polymer composition 11 N/cm, and of the acrylate composition 15 N/cm. Bond strength to a polypropylene sheet of the ethylene polymer composition >10 N/cm, and of the acrylate composition 2 N/cm.

### COMPARATIVE EXAMPLE 1

Implementation is as described in example 1, but the adhesive is composed, in accordance with standard commercial formulations, of 100 phr Vector 4113, 97 phr Escorez 1310, 21 phr Ondina 933, and 1 phr Irganox 1726.

Roll storage, 1 month at 70° C.: the roll is greatly deformed and very difficult to unwind.

Compatibility test: the PVC insulations show the first cracks after 500 hours, and the PE and PP isolations show the first cracks after 1000 hours of storage at 105° C. The tack is lost after 1000 hours; the adhesive has been soaked up by the carrier, where it has solidified.

Fogging value: 35.

### COMPARATIVE EXAMPLE 2

Implementation takes place as described in example 1, but with an adhesive comprising 100 phr LD 251, 78.4 phr Ondina 933, 212 phr Eastotac H130R (unhydrogenated C₅ hydrocarbon resin, polydispersity of 2.1, melting point 130° C.), and 8 phr Irganox 1726. The coating is not tacky, but hard with an oily surface.

### COMPARATIVE EXAMPLE 3

Implementation takes place as described in example 1, but with an adhesive comprising 100 phr Engage 7467, 78.4 phr Ondina 933, 212 phr Escorez 1310, 8 phr Irganox 1726. The coating is very soft and sticky like a flycatcher. The adhesive, as a result of the low melt viscosity, has penetrated into the carrier. It was not possible to slit the coated bale into rolls, since the adhesive splits open on unwinding. For the same reason, it is impossible to measure the bond strength (cohesive fracture). Fogging value: 37.

### COMPARATIVE EXAMPLE 4

Implementation takes place as described in example 1 but with an adhesive comprising 100 phr IN FUSE 9107, 78.4 phr Ondina 933, 212 phr Escorez 1310, 8 phr Irganox 1076. Coating takes place at 40 g/m² as in example 3. After storage of the rolls at 70° C. for 4 weeks, the paper has undergone oil strikethrough, the tack of the adhesive has reduced considerably, and the roll is deformed (hollow points). The coating is not tacky.

### COMPARATIVE EXAMPLE 5

Implementation takes place as described in example 1, but with an adhesive comprising 100 phr IN FUSE 9107, 78.4 phr PB 0300 M, 212 phr Escorez 1310, 8 phr Irganox 1076. Coating takes place as in example 3. The coating is not tacky.

### COMPARATIVE EXAMPLE 6

Implementation takes place as described in example 5, but with LD 251 instead of IN FUSE 9107. The coating is not tacky, but hard with an oily surface.

### COMPARATIVE EXAMPLE 7

Implementation takes place as described in example 5, but with Engage 7467 instead of IN FUSE 9107. The coating is very soft and tacky. No bond strength can be measured, owing to cohesive fracture.

### COMPARATIVE EXAMPLE 8

Implementation takes place as described in example 5. The adhesive is composed of the following components: 100 phr IN FUSE 9107, 78.4 phr PB 0300 M, 212 phr Escorez 5400, 8 phr Irganox 1076. The adhesive has virtually no tack.

The adhesive tape of the invention is outstandingly suitable for packaging applications, preferably reinforcement of cardboard packaging, particularly in the area of diecuts, as a tear-open strip, as a carry handle, for pallet securement, as transit securement of goods, for bundling and especially for the closing of folding cartons. Examples of such goods are PC printers or refrigerators.

The adhesive is preferably applied solventlessly on the carrier.

Moreover, it has proven advantageous for the adhesive packaging tape utility for the olefin polymer to be an ethylene polymer.

Styrene block copolymer adhesives, generally based on styrene-isoprene-styrene block copolymers, can be coated only onto polypropylene films, but not onto unplasticized PVC films.

Acrylate adhesives are unsuitable for the transit securement of goods, on account of their poor removability.

A remedy here is provided by the inventive use of the adhesive tape as an adhesive packaging tape.

The ethylene polymer preferably has a melt index of less than 6 g/10 min, more preferably less than 1.5 g/10 min, preferably a flexural modulus of less than 26 MPa, more preferably less than 17 MPa, and/or comprises a C₃ to C₁₀ olefin, preferably 1-octene as monomer.

The ethylene polymer of the invention may be combined with synthetic rubbers. These rubbers are, for example, polyisobutylene, butyl rubber, EPM, EPDM, unsaturated or hydrogenated styrene block copolymers.

It emerges, surprisingly, that tack and bond strength in the case of the new polyethylene-based adhesive are extremely dependent on the polydispersity of the resin, in contrast to conventional rubber adhesives.

Hydrocarbon resins are preferred as tackifier resins. In addition to those already specified, terpene-phenolic resins are also suitable, but result in only moderate tack, and yet also in very good shear strength and in aging resistance.

The adhesive may manage without antioxidant. This has the advantage that, in the context of application as transit securement for goods, there is no antioxidant that may possibly cause discoloration on the bonded article. The adhesive tape of the invention is then suitable for adhesive bonds with food contact. In the case of a very high thermal load during production and coating of the adhesive, the use of a phenolic antioxidant is advisable.

The plasticizer used is preferably free from mineral oil, instead being selected from the group of the liquid polymers comprising isobutene homopolymer and/or isobutene-butene copolymer and the esters of phthalic, trimellitic, citric or adipic acid, more particularly their esters with branched octanols and nonanols.

With further preference the adhesive comprises a copolymer of ethylene and but-1-ene, hex-1-ene or oct-1-ene, or a terpolymer of ethylene, propylene, and but-1-ene, hex-1-ene or oct-1-ene, the flexural modulus of the copolymer or terpolymer being preferably below 10 MPa and the crystallite melting point being preferably below 50° C., or a EPM or EPDM, preferably having an ethylene content of 40% to 70% by weight and/or a density below 0.88 g/cm³, more preferably below 0.87 g/cm³, the amount of copolymer or terpolymer being preferably above 100 phr.

Coating methods preferred are extrusion coating with slot dies and calender coating. In one specific embodiment the carrier film is composed of polyolefin and is coextruded with the adhesive.

The adhesive is applied to the carrier preferably at between 15 and 40 g/m², more preferably at between 20 and 30 g/m².

A preferred carrier is a film of unplasticized PVC (more particularly of emulsion PVC) or of polyolefin. With particular preference the film has been monoaxially or biaxially stretched in the course of its production, and/or it has, preferably, a thickness of between 25 and 200 μm, more preferably between 30 and 80 μm.

The film may have been modified by lamination, embossing or radiation treatment. The films may be provided with surface treatments. These are, for example, to promote adhesion, corona treatment, flame treatment, fluorine treatment or plasma treatment, or, on the side facing away from the release coating, coatings of solutions or dispersions, or liquid, radiation-curable materials.

The adhesive tape preferably comprises a release coating located on the side of the carrier opposite the adhesive, examples of such coatings being those of silicone, acrylates (for example, Primal® 205), stearyl compounds such as polyvinyl stearyl carbamate or chromium stearate complexes (for example, Quilon® C), or reaction products of maleic anhydride copolymers and stearyl amine. Application of the silicone may take place solventlessly or with solvent present, and the silicone may be crosslinked by radiation, by a condensation reaction or addition reaction, or physically (as for example by a block structure). The release coating is preferably based on polyvinyl stearyl carbamate or silicone. For easy-unwind adhesive packaging tapes it is preferred not to use a release coating; instead, the reverse of the film is untreated or is treated by physical methods such as corona.

### EXAMPLE A1

The carrier film used is the film R240 (former designation GA 06) from Klöckner-Pentaplast, Gendorf. It has 441 embossing (to reduce the unwind force), a thickness prior to embossing of 30 μm, and is colorless. It comprises E-PVC having a K value of 78, approximately 0.6% by weight of tin stabilizer, and approximately 3% by weight of montan ester wax. The film is produced in the Luvitherm® process.

The bottom face (where the embossing is not raised) is corona-treated and provided with a primer comprising natural rubber, cyclo rubber, and 4,4′-diisocyanatodiphenylmethane.

The adhesive is composed of the following components

| | |
|---|---|
| 100 phr | IN FUSE 9107 |
| 78 phr | Ondina 933 |
| 212 phr | PRO 10394 |
| 2 phr | Irganox 1076 |

and is applied from the melt at 25 g/m².

The bond strength to steel is 2.8 N/cm.

The tack of this example is good.

### EXAMPLE A2

The carrier film is composed of polypropylene copolymer, stretched in machine direction in a ratio of 1:7, having a thickness of 55 μm and a reddish brown coloration. It is coated on the reverse with a condensation-crosslinking silicone. No primer is used.

The adhesive is composed of the following components

| | |
|---|---|
| 100 phr | IN FUSE 9507 |
| 140 phr | Oppanol B 10 |
| 250 phr | Escorez 1310 |
| 2 phr | Irganox 1076 |

and is applied from the melt at 28 g/m².

The bond strength to steel is 6.5 N/cm. The tack is good.

### EXAMPLE A3

The carrier film is Radil TM 35 μm, comprising biaxially stretched polypropylene homopolymer. It is coated on the corona-treated side with polyvinyl stearyl carbamate from toluene solution, and on the facing side with 28 g/m² of a pressure-sensitive hotmelt adhesive with the following composition:

| | |
|---|---|
| 100 phr | IN FUSE 9107 |
| 78 phr | Ondina 933 |
| 212 phr | Foral 85 |

The bond strength to steel is 4.8 N/cm. The tack is good.

### COMPARATIVE EXAMPLE A1

Implementation takes place as described in example A3, but with a composition of

| | |
|---|---|
| 100 phr | LD 251 |
| 78 phr | Ondina 933 |
| 212 phr | Escorez 1310 |
| 2 phr | Irganox 1076 |

The coating is not adhesive, but rather hard with an oily surface.

### COMPARATIVE EXAMPLE A2

Implementation takes place as described in example A3, but with a composition of

| | |
|---|---|
| 100 phr | IN FUSE 9107 |
| 78 phr | PB 0300 M |
| 212 phr | Escorez 1310 |
| 2 phr | Irganox 1076 |

The coating is not adhesive.

The adhesive tape of the invention is also outstandingly suitable for the masking of surfaces for painting, sandblasting, plastering with mortar or transporting, especially for applications with outdoor weathering, and especially for protecting the paint finish of vehicles.

Rubber adhesives, indeed, are composed typically of natural rubber, a tackifier resin, a plasticizer, and a phenolic antioxidant, and their aging resistance and UV resistance are relatively low.

Acrylate adhesives have excellent aging stability and UV stability, but unfortunately adhere poorly to nonpolar substrates. They are irremovable from highly polar substrates such as aluminum, glass or PVC, and therefore unsuitable for such masking applications.

Particularly after prolonged weathering exposure, virtually all adhesive tapes can no longer be removed fully without residue.

The adhesive masking tape of the invention is stable to aging and to UV, the adhesion is adjustable for polar and nonpolar substrates, and it is also possible to carry out processing solventlessly.

The adhesive is preferably coated from the melt on at least one side.

Furthermore, it has emerged as being advantageous for the adhesive masking tape utility for the olefin polymer to be an ethylene polymer.

The ethylene polymer preferably has a melt index of less than 6 g/10 min, more preferably less than 1.5 g/10 min, preferably a flexural modulus of less than 26 MPa, more preferably less than 17 MPa, and/or comprises a C₃ to C₁₀ olefin, preferably 1-octene as monomer.

The ethylene polymer preferably has a structure comprising crystalline polyethylene blocks and substantially amorphous blocks of ethylene and a C₃ to C₁₀ olefin.

The ethylene polymer of the invention may be combined with the elastomers that are known for rubber adhesives, such as natural rubber or synthetic rubbers. Preference, on account of the UV stability, is given to using unsaturated elastomers such as natural rubber, SBR, NBR or unsaturated styrene block copolymers only in small amounts or, with particular preference, not at all. Synthetic rubbers with saturation in the main chain, such as polyisobutylene, butyl rubber, EPM, EPDM or hydrogenated styrene block copolymers, are preferred in the event of a desired modification.

It has surprisingly emerged that tack and bond strength in the case of the new, polyethylene-based adhesive are extremely dependent on the polydispersity of the resin, in contrast to conventional rubber adhesives.

The adhesive, according to one preferred embodiment, comprises
a primary antioxidant, preferably in an amount of at least 2, more preferably at least 6 phr, and/or with a sterically hindered phenolic group,
a secondary antioxidant in an amount of 0 to 5, preferably in an amount of 0.5 to 1, phr, and/or from the class of the sulfur compounds or from the class of the phosphites,
a light stabilizer, preferably a HALS, and/or
a UV absorber.

As a tackifier resin it has emerged that great suitability is possessed by the resins based on rosin (for example, balsam resin) or on rosin derivatives (for example, disproportionated, dimerized or esterified rosin), preferably partially or completely hydrogenated.

The adhesive preferably comprises a liquid, mineral oil-free plasticizer such as, for example, esters of phthalic, trimellitic, citric or adipic acid, wool wax, liquid rubbers (for example, low molecular mass nitrile rubbers, butadiene rubbers or polyisoprene rubbers), liquid polymers comprising pure isobutene or isobutene-butene copolymer, liquid resins and plasticizer resins having a melting point of below 40° C. and based on the raw materials of tackifier resins, more particularly the classes of tackifier resin listed above. Particular preference is given to liquid polymers of isobutene, and especially copolymers of isobutene and butene.

For the reasons given, therefore, the adhesive is substantially free from mineral oils.

For external applications it is preferred to use preferably light stabilizers and/or UV absorbers in the adhesive, such as, for example, those known under the trade names Chimassorb and Tinuvin. Particularly preferred are amine-type light stabilizers, referred to by the skilled person as HALS.

Preferred carriers are paper, woven fabric, knitted fabric, tissue, unstretched or stretched film of polypropylene, polyethylene, polyester or PVC, preferably a paper or an unstretched polypropylene film.

The pressure-sensitive adhesives may be prepared and processed from solution and also from the melt. Preferred preparation and processing methods are from the melt. For the latter case, suitable preparation operations encompass not only batch processes but also continuous processes. Particular preference is given to the continuous manufacture of the pressure-sensitive adhesive by means of an extruder and subsequent coating directly onto the target substrate, with the adhesive at an appropriately high temperature. Preferred coating processes are extrusion coating with slot dies, and calender coating.

The coat weight (coating thickness) is preferably between 10 and 120, more preferably between 20 and 70 g/m².

### EXAMPLE B1

A preferred adhesive tape for this application corresponds to that of example 2.

### EXAMPLE B2

A preferred adhesive tape for this application corresponds to that of example 4.

The adhesive tape of the invention is also outstandingly suitable for use as a wrapping tape for bundling, protecting, labeling, insulating or sealing ventilation pipes or ventilation lines in air-conditioning systems, of wires or of cables, and preferably for the wrapping of cable harnesses in vehicles and also of field coils for picture tubes.

Cable winding tapes and insulating tapes are typically composed of plasticized PVC film with a coating of pressure-sensitive adhesive on one side. Corresponding disadvantages include plasticizer evaporation and high halogen content. Winding tapes based on plasticized PVC films are used in automobiles for bandaging electrical leads to form cable looms. Although initially the primary technical purpose was to improve the electrical insulation when using these winding tapes, which were originally developed as insulating tapes, cable harness tapes of this kind are now required to fulfill further functions, such as the bundling and permanent fixing of a multiplicity of individual cables to form a stable cable strand, and the protection of the individual cables and of the entire cable strand against mechanical, thermal, and chemical damage.

Efforts are being made to replace plasticized PVC film by wovens or nonwovens, but the resultant products are little used in practice, being relatively expensive and being very different in terms of handling (for example, hand tearability, elastic resilience) and under service conditions (for example, resistance to operating fluids, electrical properties) from the usual products; as set out below, the thickness is a particularly important factor.

Also described in the (patent) literature are winding tapes with polyolefin carriers. They are furnished with adhesives comprising rubber or acrylate.

An advantage of rubber adhesives is that the adhesive properties are easy to adjust. For applications in the engine compartment, rubber adhesives are unsuitable; under the usual test conditions, depending on customer specification, after 3000 hours at 105° C., 3000 hours at 125° C. or 168 hours at 140° C., they cause embrittlement of the cable insulation of polyethylene and polypropylene, and especially of PVC, and in some cases embrittlement of the polyolefin carrier as well.

Acrylate adhesives have poor adhesion to the reverse of the film, producing a low unwind force—in other words, an unwind force, in the case of rolls stored for at least one month at 25° C., of below 1 N/cm at 300 mm/min, a figure which for application, for crease-free winding and without causing the processing personnel fatigue, should be between 1.6 and 3.0 N/cm. By corona treatment on the reverse of the film it is possible to increase the unwind force, but this force, even with a low corona output, is then already around 4 N/cm, and increases further on prolonged storage.

Pressure-sensitive silicone adhesives might provide a remedy, were they not extremely expensive and were they also available in solvent-free form.

Dispersion coatings of pressure-sensitive adhesives are potentially at risk from water exposure, leading to loss of bond strength (flagging of the end of the winding) and deterioration in the electrical properties. Solvent-based adhesives are advantageous in this respect, but do not conform to new requirements for VOC absence (VOC=volatile organic compounds) in vehicles, and do not satisfy modern-day requirements in terms of occupational hygiene and occupational safety.

Surprisingly and unforeseeably to the skilled person, a winding tape of this kind can be produced from a polyolefin film and also from a layer of pressure-sensitive polyolefin adhesive.

In accordance with one preferred embodiment of the winding tape, the carrier is composed of a halogen-free polyolefin carrier, and with further preference the adhesive is applied solventlessly.

The adhesive preferably comprises at least one polyolefin based on ethylene, propylene, 1-butene or 1-octene, more preferably a mixture of at least two such polyolefins.

The adhesive further comprises preferably a very soft olefin polymer with virtually no crystallinity. This is preferably a copolymer of ethylene, propylene, but-1-ene, hex-1-ene and/or oct-1-ene, as known, for example, under the trade names Exact®, Engage®, Versify® or Tafmer®, or a terpolymer of ethylene, propylene, but-1-ene, hex-1-ene and/or oct-1-ene, the flexural modulus being preferably below 20 MPa and the crystallite melting point being preferably below 50° C.

The carrier preferred in the winding tape in accordance with the invention comprises an olefin polymer without oxidation-sensitive double bonds and could therefore manage without antioxidant. For high long-term stability, however, it is preferred to use a primary antioxidant, and more preferably a secondary antioxidant as well. In the preferred embodiments the carriers comprise at least 2 phr, more preferably 6 phr, of primary antioxidant, or preferably at least 2 phr, more particularly at least 6 phr, of a combination of primary and secondary antioxidant, it not being necessary for the primary and secondary antioxidant functions to be present in different molecules—instead, said functions may also be combined in one molecule. The amount of secondary antioxidant is preferably up to 5 phr, more preferably 0.5 to 1 phr. Surprisingly it has been found that a combination of primary antioxidants (for example, sterically hindered phenols or C-radical scavengers such as CAS 181314-48-7) and secondary antioxidants (for example, sulfur compounds, phosphites or sterically hindered amines) produces enhanced compatibility. Particular preference is given to the combination of a primary antioxidant, preferably sterically hindered phenols having a relative molar mass of more than 500 Daltons, with a secondary antioxidant from the class of the sulfur compounds or from the class of the phosphites, preferably having a relative molar mass of more than 500 Daltons—the phenolic, the sulfur-containing, and the phosphitic functions need not be present in three different molecules; instead, more than one function may also be united in one molecule.

For applications where the winding tape is exposed for a relatively long time to the light (for example to solar radiation), it is preferred to use a light stabilizer, more preferably a HALS such as Tinuvin 111, a UV absorber such as Tinuvin P, or opaque pigment.

The film preferably comprises polyolefins based on ethylene, propylene, 1-butene or 1-octene, more preferably a mixture of polyolefins.

It may have been produced by calendering or extrusion, preferably coextrusion, such as in the blown-film or casting operation, for example. As a result of crosslinking, indeed, the winding tape is unmeltable. This is possible, for example, through ionizing radiation such as electron or γ radiation, or peroxides. A particularly preferred process is that of the coextrusion of carrier layer and pressure-sensitive adhesive layer.

The film may comprise flame retardants such as polyphosphates, carbonates and hydroxides of aluminum, of calcium or of magnesium, borates, stannates, nitrogen-based flame retardants such as melamine cyanurate, dicyanodiamide, red phosphorus, or sterically hindered amines such as, for example, the class of the HA(L)S, or halogen-containing flame retardants such as decabromodiphenyl oxide, hexabromocyclododecane, or polymers based on dibromostryene.

Further customary film additives such as fillers, pigments, light stabilizers or aging inhibitors, nucleating agents, impact modifiers or lubricants, and others, may be used for production.

The thickness of the winding tape is preferably in the range from 30 to 180 μm, more preferably 50 to 150 μm, more particularly 55 to 100 μm. The surface may be structured or smooth. Preferably, the surface is given a slightly matte finish. This may be accomplished through the use of a filler having a sufficiently high particle size or by means of a roll (for example, embossing roll on the calender or matted chill roll, or embossing roll at the extrusion stage).

The mechanical properties of the winding tape of the invention in and (machine direction) are situated preferably within the following ranges:
force at 1% elongation 0.6 to 4 N/cm, more preferably 1 to 3 N/cm
force at 100% elongation 5 to 20 N/cm, more preferably 8 to 12 N/cm
elongation at break from 200% to 1000%, more preferably from 300% to 400%
tensile strength in the range from 6 to 40 N/cm, more preferably from 8 to 15 N/cm.

For the determination of the data, the film is cut to size using sharp blades.

The winding tape of the invention preferably has a thermal stability of at least 105° C., more preferably at least 125° C. after 3000 hours, which means that, after this storage, the elongation at break is still at least 100% and the wrapped wires do not suffer embrittlement in accordance with standard LV 312.

The unwind force is between preferably 1.0 and 3.8 N/cm, more preferably between 1.6 and 3.0 N/cm.

The winding tape is outstandingly suitable for the wrapping of elongate material such as field coils or cable harnesses in vehicles. The high aging stability is outstanding. The winding tape is therefore likewise suitable for other long-term applications, such as, for example, for ventilation pipes in an air-conditioning installation. Furthermore, there is a desire for the winding tape to provide elastic contraction of the cable strand, which necessitates sufficient elongation on the part of the carrier as a result of the unwind force. These characteristics are also required for the sealing of the ventilation pipes. The high aging stability is outstanding. These properties can be achieved by a winding tape based on the polyolefin composition of the invention.

### EXAMPLE C1

The carrier film is produced by extrusion of a blown film. It consists on the outer side of an ethylene copolymer with Na ions (Surlin 1601-2 DuPont) and, on the side where coating is to take place, of LDPE (LD 251).

The film obtained is corona-treated on one side—the inner side—and then coated on the same side with 20 g/m² of a pressure-sensitive hotmelt adhesive. Slitting takes place by cutting of the resultant jumbos by means of rotating knives (round blade) into rolls with a width of 15 mm.

Composition of the pressure-sensitive hotmelt adhesive:

| | |
|---|---|
| 100 phr | IN FUSE 9107, |
| 50 phr | Wingtack 10, |
| 180 phr | Foral 85, |
| 8 phr | Irganox 1726. |

The unwind force is 2.0 N/cm, cable strands can be wrapped without creases, after storage for 3000 hours at 125° C. neither carrier film nor the wire insulations have undergone embrittlement, and the adhesive retains its adhesiveness.

### EXAMPLE C2

The carrier film is produced by first compounding, in a co-rotating twin-screw extruder, 100 phr of Hifax CA10A, 10 phr of Vinnapas B 10, 165 phr of Magnifin H 5 GV, 10 phr of Flammruss 101 lamp-type carbon black, 0.8 phr of Irganox 1010, 0.8 phr of Irganox PS 802 and 0.3 phr of Irgafos 168. The Magnifin is added at 1/3 in each of zones 1, 3, and 5. The compounded formulation is coextruded with the pressure-sensitive adhesive in a flat-film process, and wound to jumbos, which are subsequently cut. The thickness of the carrier layer is 100 μm, and that of the adhesive layer is 22 g/m².

Composition of the adhesive:

| | |
|---|---|
| 100 phr | Softell CA02A, |
| 70 phr | Oppanol B 10, |
| 180 phr | Regalite R1100, |
| 8 phr | Irganox 1726. |

The unwind force is 2.5 N/cm, cable strands can be wrapped without creases, after storage for 3000 hours at 105° C. neither carrier film nor the wire insulations have undergone embrittlement, and the adhesive retains its adhesiveness.

### COMPARATIVE EXAMPLE C1

A film as in example C1 is coated with 20 g/m² of a pressure-sensitive acrylate adhesive, and dried. The unwind force is 0.5 N/cm, and the wrapping of the cable strand is creased. After aging for 3000 hours at 105° C. and at 125° C. respectively, carrier film and wire insulations made from PP, PE, and PVC are satisfactory. After 3000 hours at 105° C., the tack of the composition is still only weak, owing to aftercrosslinking.

### COMPARATIVE EXAMPLE C2

A film as in example C1 is coated with 20 g/m² of a natural rubber, solvent-based composition comprising a rosin ester, and dried. The unwind force is 2.5 N/cm, and the wrapping of the cable strand is good. After aging for 3000 hours at 105° C., carrier film and wire insulations made from PP and PE are satisfactory, and wire insulations made from PVC have undergone embrittlement. After aging for 3000 hours at 125° C., the carrier film and all of the wire insulations have undergone embrittlement. After 3000 hours at 105° C., the composition has undergone complete embrittlement.

In addition to its use as a winding tape, the adhesive tape of the invention is especially advantageous for the wrapping of cables.

The adhesive is preferably applied solventlessly on the carrier.

It has emerged as being advantageous, moreover, for use as an adhesive cable-wrapping tape, for the olefin polymer to be an ethylene polymer and/or for the carrier to be a textile carrier.

Electrical and electromechanical components, and also the sheathings of electrical leads, are often composed of polymeric materials, with polyvinyl chloride (PVC) constituting an important plastic for historical reasons and on account of its availability and its excellent physical properties. More particularly, copper-core sheathings are predominantly composed of PVC formulations, unless alternatives become necessary as a result of boundary conditions such as high-temperature requirements or freedom from halogen.

For the mechanical and electrical protection of such cables, in the past, self-adhesive tapes were developed which are used generally for the protection and for the insulation, and also the bandaging, of electrical leads and components to a considerable extent. The self-adhesive tapes allow production of a long-term assembly without damage to the cable owing to interactions between adhesive tape and cable sheath. These tapes nowadays consist predominantly of a plasticized PVC film and a rubber adhesive. For specific applications, for example in temperature class T3 (see below) or in the case of breathability requirements, adhesive tapes with a textile carrier, such as woven polyester or viscose-staple fabric, for example, are used.

In discussions concerning the environmental compatibility of PVC, the trend is to replace this material by alternatives. Electrical components and accessories and also the sheathing of copper wires are increasingly being produced with other plastics; for more stringent applications, fluoropolymers, thermoplastic polyesters, polyurethanes, polyphenylene oxide, and crosslinked polyethylene are employed. For the cost-sensitive mass-market segment with relatively low temperature requirements, polypropylene-based materials are increasingly used.

For cable harnesses in vehicles as well, the trend is in favor of such PVC-free leads, while components such as plug connections, switches, corrugated tubes, etc., are already manufactured predominantly from PVC-free materials. In the text below, for the tests, the terms wire insulation, sheathing, cable, cable harness and leads are used synonymously.

Lengths of electrical leads, or electrical components, which are wrapped with self-adhesive tapes must ensure reliable functioning over the entire lifetime of the product as a whole, such as that of a vehicle, for example. If unsuitable adhesive tapes are selected, it is possible during the life of the product for there to be instances of incompatibility, entailing damage to the cables or even extreme embrittlement. Corrosion and short circuits, with the danger of failure of the entire electrical/electronic system, are possible consequences. Particularly in the case of vehicles such as cars or trucks, the requirements imposed on compatibility are very exacting; in the passenger compartment there may be peak temperatures of up to 80° C., while in the engine compartment there are far higher temperatures. Consequently, for the field of use of the cable wrapping tapes, a long-term test over 3000 hours, of the kind described, for example, in the automotive testing guideline LV 312, has become established as a standard test. It describes the compatibility testing in detail:

Sample cable harnesses are stored at the test temperatures and after specified periods of time, usually every 500 hours, are bent around a mandrel of defined diameter and then examined for damage. This test runs over a total time of 3000 hours. The test temperatures are guided by the temperature classes in which the cable harnesses are employed, and are 90° C. to 150° C., depending on the field of use of the cable loom in the passenger compartment or engine compartment. The LV 312 test provides that for an adhesive tape for the temperature range T2 it is necessary that compatibility be ensured between adhesive tape and wire insulation after 3000 hours at 105° C. Since in Europe the cables used in this temperature range are primarily cables with PVC sheathing, the test as well must be carried out with adhesive tape on cables of this kind. In the next higher temperature class, T3, wires with insulation made from polypropylene and radiation-crosslinked polyethylene (XPE) are primarily used for the test. The test temperature is then 125° C. instead of 105° C. In addition to the leads from certain manufacturers that are specified as a reference in LV 312, the same test can in principle also be carried out on leads which meet other international standards, such as, for example, the SAE J1128-TXL standard or the SAE J1128-TWP standard in the USA.

According to the LV 312 test method, specimen cable harnesses are produced as described below. Two identical cores with a lead cross section of 0.35 mm² are twisted with a length of lay of approximately 2 cm. The bundled leads are wrapped helically with the adhesive tape under test (width 19 mm) with an approximately 50% overlap. The leads used, for a test temperature of 105° C., are PVC leads (manufacturer designations Gebauer & Griller 67218 or Coroplast 46443).

For a test temperature of 125° C., PP leads from Tyco (manufacturer designation: AGP 0219) and XPE leads from Acome (manufacturer designation: T4104F) or from Draka (manufacturer designation: 971130) are used.

The lead harnesses wrapped with adhesive tape and comprising corresponding reference leads, and also, in addition, an unwrapped blank sample, are stored freely hanging in an oven with natural ventilation for the time of 3000 h at 105° C. or 125° C., respectively. Every 500 h a test specimen is withdrawn. The cable harness is conditioned to test conditions for at least 3 h, but for not more than 48 h, and then tested as follows.

A section of lead harness is wound around a mandrel with a diameter of 20 mm, and inspected. Thereafter the test specimen is freed from the adhesive tape and untwisted. First of all, the wrapping tape must be able to be detached without obvious damage to the lead. Subsequently, the individual cores are tested. One individual core is wound tightly at least twice around a 2 mm-diameter mandrel, the other around a 10 mm-diameter mandrel, and they are each inspected, and in each case a voltage test is carried out.

When the individual cores are tested around a 2 mm mandrel, the wire insulations must not exhibit any cracks, breaks or embrittlement, and must not have swollen or contracted, and in this case the adhesive tape is said to be compatible with the wire insulation. Discoloration of the lead is admissible. However, the original color must be still visible.

Known for cable winding applications of this kind are adhesive tapes having a tape-like carrier made from plasticized PVC film or textiles based on wovens or stitchbonded webs. Tapes with a stitchbonded web carrier are described in DE 94 01 037 U1, for example. As adhesive coating it is preferred to use pressure-sensitive adhesive coatings. To date, on textile carriers, pressure-sensitive adhesives based on natural rubber and styrene block copolymers have been used. These natural rubber based adhesives almost always exhibit weaknesses in the LV 312 compatibility test, both on PVC and on polyolefinic cable sheathing. Since natural rubber adhesives are processed from solution, this technology is not forward-looking. Adhesives based on unsaturated styrene block copolymers, which can be processed also from the melt without solvent, achieve compatibility for the temperature range T2 (3000-hour test at 105° C.) only on a few kinds of cables with PVC wire insulations, the cables used likewise being specified in accordance with the T2 temperature class. The range of damage occurring stems from slight cracks in the cable sheathing, through embrittlement, and on to complete failure by disintegration of components and wire sheathing after storage. For the T3 temperature class (3000-hour test at 125° C.), there are as yet no good pressure-sensitive adhesives; acrylates, although temperature-stable, contain solvent or cannot be coated as a dispersion onto textile carriers; one acrylate hotmelt on the market is very expensive and loses its pressure-sensitive adhesiveness on storage under T2 and T3 conditions, as a result of aftercrosslinking.

As compared with similar adhesive tapes based on natural rubber or on unsaturated styrene block copolymers, the preferred embodiment of the adhesive tape, comprising a textile carrier and the pressure-sensitive adhesive of the invention, has advantages not only in cable compatibility but also in compatibility with corrugated tubes of polypropylene and polyamide, of the kind customary in cable looms in automotive engineering.

The ethylene polymer of the invention preferably has a melt index of less than 6 g/10 min, more preferably less than 1.5 g/10 min. The flexural modulus of the ethylene polymer is preferably less than 26 MPa, more preferably less than 17 MPa.

The ethylene polymer preferably comprises a C₃ to C₁₀ olefin, more particularly 1-octene, as comonomer. The ethylene polymer preferably has a structure comprising crystalline polyethylene blocks and substantially amorphous blocks of ethylene and a C₃ to C₁₀ olefin.

Conventional textile adhesive tapes tend on storage first to deformation (formation of noses and hollow points) and secondly, as a result of cold flow of the adhesive, the unwind forces increase continually, until unwinding becomes too difficult for the user or the adhesive actually splits when an unwind attempt is made. It is a further surprising advantage of the adhesive tape of the invention, therefore, that the adhesive-tape rolls of the invention are stable on storage. Even after one month of storage at 70° C., the subject matter of the intention retains effective unwindability.

Furthermore, the LV 312 standard requires that the layer of pressure-sensitive adhesive should still exhibit pressure-sensitive adhesiveness after hot storage, in analogy to the compatibility test. Adhesive tapes based on natural rubber or on unsaturated styrene block copolymers lose their adhesiveness completely after just 500 to 1500 hours. With textile carriers, evidently, the transmission of oxygen is high enough to cause severe oxidation of the adhesive. In the case of hydrogenated styrene block copolymers, which for applications of this kind are not only too expensive but also have, essentially, inadequate bond strengths, the adhesiveness likewise retreats almost entirely. The reason for this is primarily that these adhesives melt at testing temperature, and the melt is drawn up under suction by the textile carrier, with the consequence that the pressure-sensitive adhesive is substantially no longer located on the surface. This effect is also observed with the unsaturated styrene block copolymers. Surprisingly, at 105° C., the adhesive of the invention penetrates the textile carrier only slightly, and retains good adhesiveness—when suitable aging inhibitors are used, it in fact still has very good technical adhesive data.

The ethylene polymer of the invention can be combined with elastomers of the kind known for rubber adhesives, such as natural rubber or synthetic rubbers. Preferably, unsaturated elastomers such as natural rubber, SBR, NBR or unsaturated styrene block copolymers are used only in small amounts or more preferably not at all. Synthetic rubbers with saturation in the main chain, such as polyisobutylene, butyl rubber, EPM, HNBR, EPDM or hydrogenated styrene block copolymers are preferred in the event that modification is desired.

The adhesive preferably comprises the stated plasticizers. Mineral oils are very suitable for imparting tack to the ethylene polymer, but are too volatile to achieve good fogging values (DIN 75201), in other words, for example, >60.

Conventional PVC adhesive tapes with DOP as plasticizer exhibit a fogging value of 30 to 35; in this respect, the subject matter of the invention shall at least be superior to a PVC adhesive tape. Furthermore, adhesives with trimellitate plasticizer (TOTM) or liquid polyisobutylene (for example, Oppanol® B 10) are significantly more tacky after 3000 hours of storage at 125° C. than when a mineral oil is used. For said reasons, therefore, the adhesive is preferably substantially free from mineral oils.

The melting point of the tackifier resin (determined in accordance with DIN ISO 4625) is preferably below 90° C.

The adhesive of the invention, however, comprises an ethylene polymer without oxidation-sensitive double bonds, and ought therefore to manage without antioxidant. Surprisingly it has emerged that antioxidants enhance the compatibility of the adhesive with the wire insulations.

In accordance with the invention, therefore, it is preferred to use a primary antioxidant and more preferably a secondary antioxidant as well. The adhesives of the invention, in the preferred embodiments, comprise at least 2 phr, more preferably 6 phr, of primary antioxidant, or preferably at least 2 phr, more particularly at least 6 phr, of a combination of primary and secondary antioxidant, it not being necessary for the primary and secondary antioxidant functions to be present in different molecules—instead, said functions may also be combined in one molecule.

With regard to these quantities, no account is taken of optional stabilizers such as metal deactivators or light stabilizers. The amount of secondary antioxidant is preferably up to 5 phr, more preferably 0.5 to 1 phr. Surprisingly it has been found that a combination of primary antioxidants (for example, sterically hindered phenols or C-radical scavengers such as CAS 181314-48-7) and secondary antioxidants (for example, sulfur compounds, phosphites or sterically hindered amines) produces enhanced compatibility. Particular preference is given to the combination of a primary antioxidant, preferably sterically hindered phenols having a relative molar mass of more than 500 Daltons, with a secondary antioxidant from the class of the sulfur compounds or from the class of the phosphites, preferably having a relative molar mass of more than 500 Daltons—the phenolic, the sulfur-containing, and the phosphitic functions need not be present in three different molecules; instead, more than one function may also be combined in one molecule.

The pressure-sensitive adhesives may be prepared and processed from solution and also from the melt. Preferred preparation and processing methods are from the melt. For the latter case, suitable preparation operations encompass not only batch processes but also continuous processes. Particular preference is given to the continuous manufacture of the pressure-sensitive adhesive by means of an extruder and subsequent coating directly onto the target substrate, with the adhesive at an appropriately high temperature. Preferred coating processes are extrusion coating with slot dies, and calender coating.

The coat weight (coating thickness) is preferably between 30 and 120 g/m², more preferably between 50 and 70 g/m².

As carrier material it is possible to use all known textile carriers such as a loop product or a velour, scrim, woven or knit, more particularly a PET filament woven or a nylon woven, or a nonwoven web; the term “web” embraces at least textile sheetlike structures in accordance with EN 29092 (1988) and also stitchbonded nonwovens and similar systems.

It is likewise possible to use spacer fabrics, including wovens and knits, with lamination. Spacer fabrics are mattlike layer structures comprising a cover layer of a fiber or filament fleece, an underlayer and individual retaining fibers or bundles of such fibers between these layers, said fibers being distributed over the area of the layer structure, being needled through the particle layer, and joining the cover layer and the underlayer to one another. The retaining fibers needled through the particle layer hold the cover layer and the underlayer at a distance from one another and are joined to the cover layer and the underlayer.

Suitable nonwovens include, in particular, consolidated staple fiber webs, but also filament webs, meltblown webs, and spunbonded webs, which generally require additional consolidation. Known consolidation methods for webs are mechanical, thermal, and chemical consolidation. Whereas with mechanical consolidations the fibers are mostly held together purely mechanically by entanglement of the individual fibers, by the interlooping of fiber bundles or by the stitching-in of additional threads, it is possible by thermal and by chemical techniques to obtain adhesive (with binder) or cohesive (binderless) fiber-fiber bonds. Given appropriate formulation and an appropriate process regime, these bonds may be restricted exclusively, or at least predominantly, to the fiber nodal points, so that a stable, three-dimensional network is formed while retaining the loose open structure in the web.

Webs which have proven particularly advantageous are those consolidated in particular by overstitching with separate threads or by interlooping.

Consolidated webs of this kind are produced, for example, on stitchbonding machines of the “Malifleece” type from the company Karl Mayer, formerly Malimo, and can be obtained, from sources including the companies Naue Fasertechnik and Techtex GmbH. A Malifleece is characterized in that a cross-laid web is consolidated by the formation of loops from fibers of the web.

The carrier used may also be a web of the Kunit or Multiknit type. A Kunit web is characterized in that it originates from the processing of a longitudinally oriented fiber web to form a sheetlike structure which has loops on one side and, on the other, loop feet or pile fiber folds, but possesses neither threads nor prefabricated sheetlike structures. A web of this kind too has been produced, for a relatively long time, for example on stitchbonding machines of the “Kunitylies” type from the company Karl Mayer. A further characterizing feature of this web is that, as a longitudinal-fiber web, it is able to absorb high tensile forces in the longitudinal direction. The characteristic feature of a Multiknit web relative to the Kunit web is that the web is consolidated on both the top and bottom sides by virtue of the double-sided needle punching.

Finally, stitchbonded webs are also suitable as an intermediate to form an adhesive tape. A stitchbonded web is formed from a nonwoven material having a large number of stitches extending parallel to one another. These stitches are brought about by the incorporation, by stitching or knitting, of continuous textile threads. For this type of web, stitchbonding machines of the “Maliwatt” type from the company Karl Mayer, formerly Malimo, are known.

And then the Caliweb® is outstandingly suitable. The Caliweb® consists of a thermally fixed Multiknit spacer web with two outer mesh layers and an inner pile layer, which are arranged perpendicular to the mesh layers.

Also particularly advantageous is a staple fiber web which is mechanically preconsolidated in the first step or is a wet-laid web laid hydrodynamically, in which between 2% and 50% by weight of the web fibers are fusible fibers, more particularly between 5% and 40% by weight of the fibers of the web. A web of this kind is characterized in that the fibers are laid wet or, for example, a staple fiber web is preconsolidated by the formation of loops from fibers of the web or by needling, stitching or air-jet and/or water-jet treatment. In a second step, thermofixing takes place, with the strength of the web being increased again by the complete or partial melting of the fusible fibers.

The web carrier may also be consolidated without binders, by means for example of hot embossing with structured rollers, in which case pressure, temperature, dwell time, and embossing geometry can be used to control properties like strength, thickness, density, flexibility and the like.

Starting materials envisaged for the textile carriers include, in particular, polyester, polypropylene, viscose or cotton fibers. The present invention is, however, not restricted to the stated materials; rather it is possible to use a large number of other fibers to produce the web, this being evident to the skilled worker without any need for inventive activity. Used in particular are wear-resistant polymers such as polyesters, polyolefins, polyamides or fibers of glass or of carbon.

Also suitable as carrier material is a carrier comprising a laminate in which at least the layer bearing the adhesive is a textile layer. Applied to this layer there may be one or more layers of any desired material, for example, paper (creped and/or uncreped), film (for example polyethylene, polypropylene or monoaxially or biaxially oriented polypropylene films, polyester, PA, PVC and other films), foam materials in web form (of polyethylene and polyurethane, for example), and also the stated textiles.

On the coating side it is possible for the surfaces of the carriers to have been chemically or physically pretreated, and also for their reverse to have undergone an anti-adhesive physical treatment or coating.

The adhesive tape is formed by applying the adhesive wholly or partially preferably to one or, where appropriate, both sides of the textile carrier. Coating may also take place in the form of one or more stripes in the longitudinal direction (machining direction), where appropriate in the transverse direction, but more particularly is full-area coating. Furthermore, the adhesives may be applied in patterned dot format by means of screen printing, in which case the dots of adhesive may also differ in size and/or distribution; by gravure printing of lines which join up in the longitudinal and transverse direction; by engraved-roller printing; or by flexographic printing. The adhesive may be in the form of domes (produced by screen printing) or else in another pattern such as lattices, stripes or zigzag lines. Furthermore, for example, it may also be applied by spraying, thus producing a more or less irregular pattern of application.

A feature of the adhesive tape is that it is compatible with wire insulations based on PVC and based on polyolefin, particularly for up to 3000 hours at 105° C. or even at 125° C. In one case, indeed, success was achieved in obtaining compatibility on crosslinked PE under T4 conditions (3000 hours at 150° C.).

### EXAMPLE D1

The adhesive is composed of the following components:

| | |
|---|---|
| 100 phr | IN FUSE 9107 |
| 78.4 phr | Ondina 933 |
| 212 phr | Escorez 1310 |
| 8 phr | Irganox 1726 |

The mixed melting point of resin and plasticizer is 54° C. The adhesive is prepared continuously in an extruder and applied from the melt by nozzle coating at 70 g/m² to a woven polyester fabric. The filament fabric has a basis weight of 130 g/m², comprising polyester yarn of 167 dtex with 45 threads per cm in warp direction and 25 threads per cm in weft direction. The coated bale is processed by slitting into rolls in a width of 19 mm and a running length of 10 m; the internal core diameter is 38 mm.

Bond strength to steel 6.6 N/cm

Bond strength to reverse 3.1 N/cm

Roll storage, 1 month at 70° C.: the roll is slightly deformed and readily unwindable.

Compatibility testing: the completed adhesive tape is wound as per LV 312 around a wire pair with different insulating materials, and stored at the corresponding temperature. Six such test specimens are produced per insulating material. Every 500 hours, one of the specimens is checked, the adhesive tape is unwound again, and the cable is wound around a mandrel of 10 mm in diameter and around a mandrel of 2 mm in diameter. Investigation is carried out to determine whether the insulation is damaged and whether the adhesive exhibits adhesiveness. Test temperatures: PVC 105° C., and on crosslinked PE at 125° C. After 3000 hours, all of the wire insulations are still undamaged. After 3000 hours at 105° C., the adhesive has undergone virtually no penetration into the carrier, and still has good adhesiveness. After 3000 hours at 125° C., the adhesive has undergone partial penetration into the carrier, but is still adhesive.

Fogging value: 36

### EXAMPLE D2

Adhesive as in example D1 but with Eastotac C 130 L instead of Escorez 1310 and 5 phr of Irganox 1076 and 3 phr of Irganox PS 802 instead of 8 phr of Irganox 1726, coating as in example D1 but at 60 g/m² on the following carrier: Malifleece with a basis weight of 150 g/m², consisting of polyester fibers with a linear density of 3.3 dtex and a fiber length of 60 to 80 mm, and 5% by weight of a thermally activated fine binding powder (Vinnex TM LL 2321). The mixed melting point of resin and plasticizer is 90° C.

Bond strength to steel 4.3 N/cm

Bond strength to reverse 1.3 N/cm

Roll storage, 1 month at 70° C.: the roll is slightly deformed and readily unwindable.

Compatibility testing on PVC at 105° C. and on crosslinked PE and PP at 125° C.:

After 3000 hours, all of the wire insulations are still undamaged. After 3000 hours at 105° C., the adhesive has undergone virtually no penetration into the carrier, and still has good adhesiveness. After 3000 hours at 125° C., the adhesive has undergone partial penetration into the carrier, but is still adhesive.

### EXAMPLE D3

Adhesive as in example D1 but with Eastotac C 115 L instead of Escorez 1310, coating as in example D1 at 68 g/m² on the following carrier: Maliwatt stitchbonded knit composed of polyester fibers with about 3.4 dtex and a fiber length of about 80 mm, a basis weight of 72 g/m² and a fineness F 22 with a stitch length of 1 mm of a 50 dtex polyester yarn. The mixed melting point of resin and plasticizer is 75° C.

Bond strength to steel 4.2 N/cm

Bond strength to reverse 1.6 N/cm

Roll storage, 1 month at 70° C.: the roll is slightly deformed and readily unwindable.

Compatibility testing on PVC at 105° C. and on crosslinked PE and PP at 125° C.:

After 3000 hours, all of the wire insulations are still undamaged. After 3000 hours at 105° C., the adhesive has undergone virtually no penetration into the carrier, and still has good adhesiveness. After 3000 hours at 125° C., the adhesive has undergone partial penetration into the carrier, but is still adhesive.

### EXAMPLE D4

Adhesive as in example D1 but with Escorez 1102 instead of Escorez 1310, coating as in example D1 at 70 g/m² on the following carrier: Malifleece web of polypropylene with a basis weight of 80 g/m² and a fineness F 18. The mixed melting point of resin and plasticizer is 60° C.

Bond strength to steel 0.8 N/cm, bond strength to reverse 0.2 N/cm.

After 4 weeks of storage at room temperature, the adhesive is no longer tacky. Roll storage, 1 month at 70° C.: the roll is slightly deformed and readily unwindable.

Compatibility testing on PVC, crosslinked PE and PP at 105° C.:

After 3000 hours at 105° C., all of the wire insulations are still undamaged. After 3000 hours at 105° C., the adhesive has undergone virtually no penetration into the carrier, and still has good adhesiveness. After 3000 hours at 125° C., the web carrier has disintegrated as a result of embrittlement, and therefore no further tests can be performed.

### EXAMPLE D5

Production takes place as in example D1, the adhesive being composed of the following components:

| | |
|---|---|
| 100 phr | IN FUSE 9107 |
| 100 phr | Engage 7467 |
| 425 phr | Escorez 1310 |
| 16 phr | Irganox 1726 |

Bond strength to steel 5 N/cm, bond strength to reverse 2.5 N/cm

Roll storage, 1 month at 70° C.: the roll is slightly deformed and readily unwindable.

Compatibility testing: test temperatures: PVC 105° C. and on crosslinked PE at 125 and 150° C. After 3000 hours, all of the wire insulations are still undamaged. After 3000 hours at 105° C., the adhesive has undergone virtually no penetration into the carrier, and still has good adhesiveness. After 3000 hours at 125° C., the adhesive has undergone partial penetration into the carrier, but is still adhesive.

Fogging value: 85

### EXAMPLE D6

Production takes place as in example D1, the adhesive being composed of the following components:

| | |
|---|---|
| 100 phr | IN FUSE 9507 |
| 250 phr | Regalite 1100 |
| 140 phr | Oppanol B 10 |
| 8 phr | Irganox 1726 |

The mixed melting point of resin and plasticizer is 67° C. Coating takes place at 70 g/m² on a carrier as in example D3.

Bond strength to steel 8.9 N/cm, bond strength to reverse 2.0 N/cm

Compatibility testing: test temperatures: PVC 105° C. and on crosslinked PE at 125 and 150° C. After 3000 hours, all of the wire insulations are still undamaged. After 3000 hours at 105° C., the adhesive still has good adhesiveness. After 3000 hours at 125° C., the adhesive still has some adhesiveness. After 3000 hours at 150° C., the adhesive has undergone substantial degradation, but the wire insulation is still undamaged.

Fogging value: 91.

### EXAMPLE D7

Production takes place as in example D1, the adhesive being composed of the following components:

| | |
|---|---|
| 100 phr | IN FUSE 9107 |
| 212 phr | Foral 85 |
| 40 phr | TOTM |
| 8 phr | Irganox 1726 |

The mixed melting point of resin and plasticizer is 67° C. Coating takes place at 70 g/m² on a carrier as in example D3.

Bond strength to steel 8.9 N/cm, bond strength to reverse 2.0 N/cm

Compatibility testing: test temperatures: PVC 105° C. and on crosslinked PE at 125 and 150° C. After 3000 hours, all of the wire insulations are still undamaged. After 3000 hours at 105° C., the adhesive still has good adhesiveness. After 3000 hours at 125° C., the adhesive still has some adhesiveness. After 3000 hours at 150° C., the adhesive has undergone substantial degradation, but the wire insulation is still undamaged.

### COMPARATIVE EXAMPLE D1

Implementation is as described in example D1, but the adhesive, in line with standard commercial formulations, is composed of

| | |
|---|---|
| 100 phr | Vector 4113 |
| 97 phr | Escorez 1310 |
| 21 phr | Ondina 933 |
| 1 phr | Irganox 1726 |

Roll storage, 1 month at 70° C.: the roll is highly deformed and very difficult to unwind.

Compatibility testing: the PVC insulations exhibit the first cracks after 500 hours, and the PE and PP insulations after 1000 hours, of storage at 105° C. The adhesiveness is lost after 1000 hours; the adhesive has been drawn up under suction by the carrier, where it has formed a varnish-like film.

### COMPARATIVE EXAMPLE D2

Implementation is as described in example D1, but with LD 251 instead of IN FUSE 9107. The coating, rather than being adhesive, is hard with an oily surface.

### COMPARATIVE EXAMPLE D3

Implementation is as described in example D1, but with Engage 7467 instead of IN FUSE 9107. The coating is very soft and sticky like a flycatcher. The adhesive has penetrated the carrier, owing to its low melt viscosity. The coated bale could not be slit into rolls, since the adhesive splits on unwinding. For this reason, it is likewise not possible to measure bond strength (cohesive fracture).

### COMPARATIVE EXAMPLE D4

Implementation takes place as in example D1, the adhesive being composed of the following components:

| | |
|---|---|
| 100 phr | IN FUSE 9107, |
| 78.4 phr | PB 0300 M, |
| 212 phr | Escorez 5400, |
| 8 phr | Irganox 1076. |

The adhesive has virtually no adhesiveness.

The adhesive tape of the invention is especially advantageous, moreover, for outdoor applications, especially when, in accordance with another advantageous embodiment of the invention, the adhesive tape has a textile carrier having a basis weight of 15 to 150 g/m² and provided on the top face with an additional layer, applied by extrusion coating, by dispersion coating or by film lamination, and furnished on the bottom face with an adhesive comprising an ethylene polymer having a density of between 0.86 and 0.89 g/cm³ and a crystallite melting point of at least 105° C., and comprising a tackifier resin.

Woven-fabric-backed adhesive tapes, consisting of a woven textile as carrier material and a single-sidedly applied layer of a self-adhesive, are among one of the oldest kinds of self-adhesive systems in the form of a roll product. First used in the medical sector, in the second half of the last century they became a partial replacement for plasticized PVC insulating tapes in the bandaging of cable harnesses in automobiles.

On account of the unusual combination of flexibility and conformability properties, and high mechanical strength in conjunction with transverse tearability by hand, the spectrum of use expanded greatly. Woven-fabric-backed adhesive tapes can be used for bandaging, repairing, masking, fixing, marking, etc., and can be separated into appropriate lengths by hand, without scissors, knives or other tools. Consequently they represent universal adhesive tapes (known as multi-purpose or general purpose tapes), adhering to a large number of substrates, whether polar or nonpolar, rough or smooth, and are utilized for virtually all conceivable applications.

The adhesive used is almost exclusively selected from natural or synthetic rubber formulations. In addition to this historical aspect (natural rubber as a main constituent of the first industrially available self-adhesives), it is the adhesive properties in particular, which are balanced in terms of adhesion, tack, and cohesion, and are ideally suitable for universal adhesive tapes of this kind. Carrier materials used are dense woven textiles of preferably (modified) natural fibers such as cotton, viscose staple, viscose, etc.

To start with, woven-fabric-backed adhesive tapes comprising uncoated woven fabric, as raw fabric or else yarn-dyed, were produced with a coating of adhesive on one side only. As a result of the open weave structure, however, the rubber adhesive is open to easy attack on the reverse side: oxygen, aggressive substances such as solvents, UV radiation or solar radiation, etc., have virtually unhindered access.

For this reason, and also for protecting the woven fabric itself, polymer coatings were applied to the top face of the adhesive tape. In this context it is possible to differentiate three types of woven-fabric-backed adhesive tapes on the basis of the construction of the product:
The most high-grade products utilize a dense fabric having a basis weight of predominantly 70 to 150 g/m² with a mesh count (sum of the threads in warp and weft directions, in each case per inch) in an order of magnitude of 100 to 250 inch⁻², with a usually colored polymeric coating of PVC, acrylate, polyurethane or the like, applied single-sidedly from dispersions or organosols. These products originated in central Europe and are predominantly produced there as well. An example of one such premium tape would be Tesa® 4651.
Tending to be of Asian origin are woven-fabric-backed adhesive tapes having a lighter, open, netlike weave of 40 to 100 mesh, with a PE film with a thickness of 50 to 200 μm being extruded onto the fabric. Fabric and film usually form a stable, robust assembly. On account of their positioning in terms of price and properties, they are also termed “mid grades”. An example is Tesa® 4688.
Coming originally from North America, the tapes known as duct tapes have spread globally. In these tapes, very open woven, scrim or knitted fabrics of 25 to 40 mesh are used, with a basis weight of 15 to 40 g/m², onto which, with a part of the self-adhesive, a usually colored, opaque PE film is laminated. The durability of the film/textile carrier assembly is determined solely by the bond strength and aging stability of the adhesive. In terms of price, this kind of woven-fabric tapes represents the bottommost category and is used usually in the silver color. From among the multitude of commercial duct tapes, Tesa® 4662 may be cited here as an example.

Adhesive tapes of this kind generally have an overall thickness of 200 to 400 μm, with the layer of adhesive contributing about 50 to 250 μm, and in terms of their construction are designed primarily for interior applications.

As universal adhesive tapes, however, they are also used in exterior applications. Exposure to light, direct insolution, moisture, heat, microorganisms, etc., then, however, cause weaknesses to come to light, which may lead to instances of damage to the adhesive tapes, possibly going as far as their complete destruction:
rubber adhesives with double bonds in the elastomers are attacked and damaged by UV light, oxygen, and ozone, and thereby lose their original adhesive properties.
Woven fabrics of cotton, viscose, viscose staple, etc., are attacked by microorganisms. In the presence of moisture, heat, and light, this component, which is critical for the mechanical strength properties of the adhesive tape, suffers rotting.
Water absorption in the woven fabric owing to the suction capacity of the yarns results, through swelling, in the weakening of the assembly and in losses of strength.

Attempts to date to develop suitable high-grade universal woven-fabric-backed adhesive tapes for long-term exterior applications, in the form of what are called outdoor tapes, have to date seen only limited success, if any.

A high-grade but costly woven-fabric-backed adhesive tape comprising a dense, 200 to 250 mesh viscose acetate fabric, is described in U.S. Pat. No. 3,853,598 A1. The fabric is given a polyacrylate primer layer, to which adhesive comprising synthetic rubber and natural rubber is applied. As a result of the fabric of very high mesh count and the treatment of the fabric with a polyacrylate primer, the adhesive tape exhibits good and very easy hand tearability. References to outdoor suitability, however, are absent. The chosen adhesive, and particularly the woven fabric with no top-face protection and with modified natural fibers as its basis, also suggest no such suitability. Only medical, i.e., interior applications are explicitly stated.

A technical adhesive tape, particularly for the construction sector, is described in EP 1 548 080 A1. Although the adhesive used is stable to weathering, being a UV-crosslinked acrylate adhesive on a tapelike carrier, the selection of carriers, with papers and also films, wovens or nonwovens of PE, PP or PET, does not suggest a slant toward outdoor applications. Easy transverse tearability by hand, as is mandatory for a general purpose tape, is absent. With UV-crosslinkable acrylate adhesives, moreover, there is a latent risk that, under exposure to sunlight, any established crosslinking that is not complete in the course of manufacture will continue and hence there will be adverse alteration of the adhesive properties in the course of the service life.

A specialty tape for long-term outdoor applications which after 500 hours in the ASTM G155 weathering test exhibits less than 10% adhesive residues is described in WO 03/097758 A1. Essential to this tape is the multi-ply polymeric PE film on the top face, containing up to 35% of light stabilizer additives. For the remaining components of the adhesive tape, such as a 10 to 90 mesh scrim, and also the self-adhesive, no particular details are described. It can therefore be assumed that the multi-ply film on the surface results in large-area protection against (UV) light, but that ingress of oxygen, ozone, etc. at the margin can lead to unwanted changes to the adhesive at the edges of the adhesive tape. Moreover, with the described construction of the carrier from a 50 to 100 μm thick, multi-ply PE film and a 10 to 90 mesh scrim, the frayed torn edges typical of duct tapes are likely, and cannot be accepted for a high-grade woven-fabric-backed adhesive tape. Furthermore, the high fraction of light stabilizer additives and also the multi-ply film structure suggest correspondingly high manufacturing costs.

EP 1 074 595 A1 describes a polyester woven fabric tape which owes its hand tearability to the selection of specific yarns, to defined weave construction (not more than 2500 dtex/cm as linear density of the longitudinal threads per unit length), and to the fixing—described as being necessary—of the warp threads by the coating of adhesive. Here, therefore, there are specific conditions which must be met in order to achieve at least a tear strength of less than 10 N in transverse direction. The description of the yarn parameters and weave parameters indicates, to a person skilled in the art, a lightweight fabric significantly below 100 g/m², which, not entirely surprisingly, per se already possesses relatively low strength, solely by virtue of the reduction in basis weight, yet becomes hand-tearable owing, furthermore, to the layer of adhesive which is intended to fix the warp threads in their place. Here, moreover, wrongly, a tear propagation resistance of less than 10 N is associated with the property of hand tearability. In practice, however, simple hand tearability is significantly governed not only by the above-described tear propagation resistance but by the force for initial tearing into the carrier—which, however, is critically influenced by further parameters such as the stress/strain behavior of the carrier, the slitting technology used and the quality of slitting, etc., parameters of which the laid-open specification provides no information.

DE 10 2005 044 942 A1 describes a transversely tearable adhesive tape having an uncoated textile fabric carrier based on polyester or polyamide, where the reduction in fiber strength and hence the hand tearability is accomplished by controlled damaging of the yarn (in the case of PET, using alkalis; in the case of polyamide, using acids). Additional impregnation with slip-resistance chemicals such as silicates is said to improve the hand tearability further. The alkalization of woven PET fabric, for example, though, is associated with a marked loss of strength, which is adversely manifested on aging, thermal stressing, flexural and/or tensile load, and with an increase in the gas permeability and vapor permeability. The latter effect, which is advantageous in the context of medical applications, becomes the opposite in industrial applications, since oxygen, ozone, and comparably aggressive gases and liquids are able to penetrate without hindrance through to the adhesive and hence to damage the adhesive more greatly than in the case of untreated or even coated fabrics.

Despite the large number of woven-fabric-backed adhesive tapes in the industrial, medical, and consumer sectors, a hand-tearable, weather-stable, universal woven-fabric tape for relatively long-term outdoor applications is unknown.

The adhesive tape of the invention with the woven fabric carrier resolves the requirements imposed
it is readily hand-tearable.
It adheres to a large number of substrates that are common in everyday use, including rough and/or contaminated substrates such as unsanded sawn wood, concrete, brick or plaster.
Even in relatively long use of at least six months outdoors (central Europe), it does not lose its bonding functionality.

The yardstick employed for this is a decrease in the relevant measurement values by not more than 50%, as for example for the ultimate tensile strength and elongation at break in longitudinal direction, and also the bond strength to steel, in accordance with AFERA 5001. Changes in optical properties as well, such as significant instances of destruction or cracks, marked discolorations or fades, instances of detachment from the substrates, should also be avoided in accordance with the invention.

In a first advantageous embodiment of the invention, the adhesive tape comprises a textile carrier comprising a very open woven, scrim or knitted fabric of 25 to 40 mesh and with a basis weight of 15 to 40 g/m². Present on the top face is a UV-stabilized PE film having a thickness of 50 to 200 μm, which preferably, as a result of fillers and colorant pigments, is not transparent and more particularly is UV-impervious. By means of advantageous aging inhibitors and UV stabilizers used additionally in the PE film, and also as a result of the UV impermeability of the PE film, the adhesive below the carrier is additionally protected against photooxidative attack.

In this embodiment, the actual carrier is a laminate, which is produced from the textile and the PE film particularly in situ as part of the operation of coating the adhesive. A small part of the adhesive is pressed under pressure through the open textile and acts as a laminating adhesive. The side of the textile carrier with the small amount of adhesive is laminated with the PE film. This produces an assembly of film, laminating adhesive, and textile.

As and where necessary, the PE film may be provided on the open side facing away from the adhesive, inline or offline, with a release beforehand, in order to ensure ease of unwind.

In principle, the pre-production of a laminate from a film, to which the laminating adhesive is applied and is subsequently lined with the textile, before the coating of the adhesive onto the opposite side of the textile, results in comparable products.

The embodiment described here relates to a carrier for the duct tapes category already described above, such as Tesa® 4662, for example.

In accordance with a further advantageous embodiment of the invention, the textile carrier of the adhesive tape is composed of an open, netlike woven fabric of 40 to 100 mesh and with a basis weight of 20 to 60 g/m², onto which a PE film 50 to 200 μm thick is extruded. Woven fabric and film usually form a stable, robust assembly. As with the duct tapes, suitable UV stabilization may also take place here via UV stabilizers, aging inhibitors, and the coloring process. As and when necessary, a release provision may be applied on the open side of the PE film, facing away from the adhesive. This kind of carrier relates to the mid grades category already described earlier on above, such as Tesa® 4688, for example.

In accordance with a further advantageous embodiment of the invention, the textile carrier of the adhesive tape is composed of an 80 to 250 mesh woven PET fabric having a grammage of 50 to 150 g/m², the top face of this fabric being coated with a dispersion paste, more particularly an aqueous acrylate paste, having an application weight of 15 to 75 g/m².

The woven fabric having a grammage of 50 to 150 g/m², more particularly having 70 to 130 g/m², is selected such that the particular construction imparts an at least moderate capacity for tear initiation and tear completion by hand in the transverse direction (also called the weft direction or CD). This woven fabric is coated on one side with a colored, aqueous acrylate paste or, similarly, with an application weight of 15 to 75 g/m², more particularly 25 to 50 g/m².

The woven fabric carrier is particularly advantageous when the color-imparting coating is applied in two coats in succession with two different formulas. The main fraction is applied as a color-imparting basecoat at 10 to 60 g/m² directly onto the fabric. Through use of an acrylate binder having a glass transition point of 0° C. or less, a soft and elastic coating is obtained, which is beneficial to the flexibility and the hand of the carrier and which promotes conformant bonding of the woven-fabric-backed adhesive tape.

Applied atop this sometimes somewhat blocking (i.e. sticking under pressure) color coating, in a second coat, is 5 to 20 g/m² of a hard, resistant topcoat. This increases the resistance of the adhesive tape surface not only to its own adhesive (direct contact during production, transport, and on storage in the form of an adhesive tape roll) but also, in the subsequent application, to all possible influences such as mechanical stresses, visible, infrared or ultraviolet radiation, water, chemicals, etc.

The topcoat is selected preferably from acrylate dispersions into which hardening comonomers have been copolymerized, such as styrene, methacrylate, acrylonitrile, for example.

The carrier of the invention in the form of an assembly system comprising a woven PET fabric and the preferred acrylate coating features not only very good resistance properties toward a large number of different stresses of the kind that occur in connection with outdoor applications, but also handing properties which are improved relative to the untreated woven fabric. Capacity for tear initiation and tear completion in transverse direction is provided readily, without use of slitting tools, as is a flexibility for contour-conforming bonds.

With this assembly carrier, a woven-fabric-backed adhesive tape of the premium class is obtained, as represented by Tesa® 4651, for example.

Through a skilful choice of the yarns, the construction for the woven fabric, and the operating steps, it is possible to produce woven PET fabric in the target grammage range of 50 to 150 g/m², more particularly 70 to 130 g/m², with thicknesses of below 100 to 250 μm, with satisfactory hand tearability and tear propagation qualities. Using the method described in DE 10 2005 044 942 A1 for the damaging of the yarn, the strengths are lowered in a controlled way, allowing the establishment of a balanced relationship between remaining ultimate tensile strength in warp direction, and transverse tearability. As an alternative to this, the woven fabric may be constructed in such a way that the warp, which must be severed in the subsequent fabric when it is torn through transversely, is selected such that the individual warp threads permit this without an unreasonable application of force.

Either the thread cross section is reduced, allowing the threads to be torn through without problems, or else an acceptable severing behavior is established via the selection of material for the warp. In order to achieve total strength in the warp direction (MD=machine direction) sufficiently in the subsequent fabric, the number of threads per unit length must be selected so as to achieve the desired MD ultimate tensile strength of not less than 40 N/cm and not more than 100 N/cm. The ideal target for the premium woven-fabric-backed adhesive tape is an MD ultimate tensile strength of 60 to 80 N/cm. Suitable for the warp, for example, is PET yarn of 75 den or finer linear density, but also brittle materials, which when energy is introduced in a pulsed fashion during the tearing procedure, result in breaking of the warp thread: PET fibers with suitable comonomers or crystallization, or else warp yarn based on PA6,6. In order with such warps to obtain a woven fabric having target tactility and optical properties, the weft threads selected must be correspondingly thicker and heavier. One effect of this is an increase in the basis weight into the range of 70 g/m² or more, while another is that the target thicknesses for the woven fabric, of 100 to 250 μm, are achieved; the woven fabric as well, in spite of the thin warp threads, gives a high-grade effect, since the thicker weft threads determine the optical qualities. PET weft yarns from 150 den onward are possible, with a 300 den PET yarn being particularly advantageous in terms of optical and tactility qualities.

Similar comments apply to the use of other synthetic polymers in place of PET as a material for the yarn, such as other types of polyester, for example (PBT, PEN), polyamide (PA), polyacrylates, polyimides, polypropylene.

A further possibility for producing a base fabric of the invention having acceptable tear initiation and tear completion qualities in transverse direction is to use, for the warp in particular, yarns comprising a fiber blend, with at least one of these types of fiber being soluble and hence subsequently removable. The result would therefore be a yarn with sufficient strength for the spinning and weaving operation, with thinning and weakening taking place only in a downstream operating step, and resulting in the desired property of transverse tearability for the fabric. Fiber blends which may be contemplated include diverse combinations, it being appropriate to use resistant polymers as permanent warp yarn, such as PET fibers, for example, in combination with water-soluble, or chemically or enzymatically degradable, materials such as polyvinyl alcohol, polylactates, and the like. Depending on the fiber combination selected, the blending proportions should be chosen such that the ultimate strength of the (warp) yarn comes to be situated within the target range.

Although self-adhesive tapes can be produced with uncoated woven fabrics of this kind, a premium universal woven-fabric tape requires a high-grade single-sided polymeric coating in order to achieve a smooth, homogeneous surface and in order that the woven fabric is closed, keeping aggressive chemicals away from the adhesive and the bond substrate. Furthermore, cost-effective and flexible coloration is achieved via this coating, since coloring of the woven fabric itself is more costly and inconvenient. Surprisingly, further to these known aspects, it emerged that the inventive color coating significantly improves the hand tearability of the crude fabric with appropriate formulas, and so stresses on the fabric itself in this regard can be reduced. In the case of the single-side coating of a suitable color paste on the top face, this coating penetrates into the fabric, at least to half the fabric thickness, as a result of the three-dimensionally structured surface. After the polymeric layer has dried and/or cured, the warp threads and weft threads are geometrically fixed, similar to the mandatory format required by EP 1 074 595 A1 for the warp threads by virtue of the coating of adhesive.

For the polymeric coatings there are in principle a multiplicity of systems that are possible, such as organosols, radiation-crosslinkable prepolymer systems, nonadhesive hotmelts, polymer solutions, etc. Preferred and established, in contrast, are aqueous dispersions, for reasons of cost, availability, and existence of standard application technologies in the textile sector.

Materials which can be selected include, for example, polyurethanes, (ethylene-)vinyl acetate systems, PVC systems, styrene-butadiene systems or acrylate systems. For reasons of ecology, cost, availability, and with regard to the “outdoor application/weathering stability” requirement, acrylates are preferred. Depending on the coating technology present, they are thickened and dispersed with corresponding color pastes/pigments, in order to produce the single-sided, color-imparting coating.

Proven particularly advantageous has been a two-coat system: In order to achieve a good “hand” on the part of the final woven fabric tape, which means pleasant touch, conformable and flexible behavior, allowing the adhesive tape to be adhered effectively even to curved, uneven surfaces, the color-imparting basecoat ought to be soft and flexible; the glass transition temperature for the binder in the color paste ought to be below room temperature, more particularly in the region of 0° C. or lower.

For good resistance on the part of the adhesive tape, in contrast, a hard, chemically resistant finish coat is favorable. A topcoat of this kind not only protects the layers beneath it, but also—if correctly selected—acts as a barrier layer against the adhesive, which in the subsequent adhesive-tape roll lies in direct contact with the topcoat. Interactions such as migration of constituents of the adhesive into the polymeric coating or vice versa are unwanted, since they lead to alterations in the respective properties, and, in an extreme case, the defined interface between adhesive and plastics surface is dissolved. The consequence of this would be severe peel increase on the part of the adhesive, and hence high unwind forces. Topcoats, especially those based on acrylate, having a glass transition temperature above room temperature, more particularly from 30 to 50° C. and above, are suitable, as are chemically or thermally crosslinking systems, if the final film properties are situated within the same range. The topcoat, however, must also not be too hard, since otherwise cracks occur in the case of bonds around narrow radii, as a result of flexing or creasing in the topcoat, and hence the coherent coating film is damaged.

The color-imparting polymeric coating should be applied in total at 15 to 75 g/m², more particularly 20 to 50 g/m², in order to achieve effective coloration, a coherent film, and a uniform surface structure. In the case of the two-coat approach, the basecoat, at 50% to 95%, constitutes the major proportion. For reasons of reduced complexity it has proven favorable to apply the basecoat in pigmented form with 70% to 95% of the total amount as color-imparting layer, and the topcoat at 5% to 30%, as an unpigmented, transparent topcoat finish. As far as formulation and operational parameters are concerned, it is necessary to ensure on the one hand that the adhesion of the basecoat to the untreated fabric is high, but also, on the other hand, that the intercoat adhesion between basecoat and topcoat is high, so that, in the subsequent adhesive tape, there are no instances of tear separation or detachment of the color-imparting polymeric layer, as for example on unwinding from the roll.

If necessary, as for example when ease of unwind from the adhesive-tape roll is desired, the topcoat may be admixed with one or more release additives, or else a separate release coating/release printing may be applied to the open side facing away from the adhesive.

The universal woven-fabric tape of the invention with suitability for relatively long-term outdoor applications is characterized by the following construction and production, in which context the description should be considered as being given by way of example, and can be utilized by a skilled person in modified form, without thereby departing the property-right sphere of the present specification. Applied to the carriers described above as being advantageous, on one side, as an adhesive layer, are 50 to 300 g/m², more particularly 70 to 150 g/m², of the UV-resistant and moisture-resistant self-adhesive, in order to ensure reliable bonding in indoor and outdoor applications on smooth, structured, and rough substrates.

The adhesive of the adhesive tape described here may comprise the disclosed antioxidants, including a combination of primary antioxidants (for example, sterically hindered phenols or C radical scavengers such as CAS 181314-48-7) and secondary antioxidants (for example, sulfur compounds, phosphites or sterically hindered amines).

The general rule with the universal woven-fabric tapes of the invention, for reasons of handling and on account of the high bond strengths, is to provide the non-adhesive-facing top face of the carrier with an antiadhesive release system. As is known to the skilled person, silicone systems offer the option of easy to very easy unwind force, while fatty acid derivatives such as polyvinyl stearyl carbamate, for example, tend to produce moderate unwind forces of several N/cm. Since average unwind forces of 2 to 8 N/cm are established for woven-fabric tapes, preference is given to choosing a surface coating or surface printing with a release agent such as polyvinyl stearyl carbamate or a reaction product of stearyl isocyanate and polyethyleneimine.

With this product construction according to the invention, woven-fabric-backed adhesive tapes are obtained which bond effectively and securely to a wide variety of substrates. On steel, as a standard adhesion base for polar substrates, a bond strength in the fresh state (not more than one week after production) is achieved of a minimum of 5 N/cm, and on polyethylene, as a nonpolar substrate, a bond strength in the fresh state of at least 4 N/cm is achieved, and these values, as required, are retained to an extent of at least 50% over six months.

On account of the high bond strengths and the high peel increase on both polar and nonpolar surfaces, the adhesion of the adhesive tape of the invention after just a short time is strong enough that it can no longer be removed without residue thereafter and, understandably, in particular after use for up to six months. The adhesion and other functionality as a self-adhesive tape, however, are influenced little if at all. For this reason, adhesive tapes of this kind are especially appropriate for relatively long-term, permanent adhesive bonds in the outdoor sector.

Universal woven-fabric tapes of the invention can be separated into appropriate lengths, easily and with a straight tear edge, without fraying, by hand in the transverse direction. In machine direction, in contrast, the woven-fabric tape has sufficient strengths, and can therefore be used for numerous bandaging and fixing applications where tensile strength is a requirement. Usually a slightly increased initial force is needed to tear into the edge, with further tearing then taking place easily and uniformly. This slightly increased initial-tear force has the advantageous effect of protecting the woven-fabric tape from unintended severing during handling and also in the final application.

In outdoor applications, the universal woven-fabric-backed adhesive tape of the invention proves to be extremely stable and to be suitable for long-term applications of at least six months. Whereas the existing duct tapes in particular consistently disintegrate into their constituents after a few weeks under direct exposure to sunlight and rain, the functionality and product integrity are retained with the woven-fabric tape of the invention:
sufficient strength for mechanical stresses,
retention of the integrity of the multi-ply construction of the adhesive tape,
good long-term adhesion to the substrate.

This is not the case with the known natural-rubber and synthetic-rubber woven-fabric tapes, since the framework elastomer is destroyed via attack on the double bonds, and in some cases the carrier component as well suffers significantly irreversible damage.

As well as being suitable for outdoor applications where existing woven-fabric tapes exhibit marked weaknesses, the adhesive tapes of the invention, as universal adhesive tapes, are of course also suitable for interior applications, something which for the skilled person requires no separate mention.

Virtually independently of the nature of the adhesive used, a universal woven-fabric tape of the invention requires a certain layer thickness for the adhesive in order to bond reliably even to rough or structured substrates such as wood, stone, concrete, etc. At a coat weight of 50 to 300 g/m², more particularly 70 to 150 g/m², the desired bonding performance is achieved; the absolute amount of the layer thickness effective in adhesive terms is dependent on factors including the structure of the woven fabric. Depending on the roughness of the side where coating is to take place, amounts of up to 50 g/m² are required solely to fill the depressions in the woven fabric, without this portion of the adhesive protruding beyond the “peaks of the woven-fabric mountain range” and being available for adhesive bonds. As a rough guideline for the quantity of composition required in light of the target bonding performance, an “effective” coat thickness of 50 to 150 μm may be quoted.

On the coating side, the surfaces of the carriers may be given an adhesion-friendly finish, by means, for example, of an anchorage coat or physical pretreatment, such as by means of corona irradiation, for example. Normally, however, the rough structure of the woven fabric and also the affinity of the surface for the adhesive offer sufficient anchorage, and so there may be no need for separate operating steps.

The coating technology is to be selected as a function of the formula and viscosity of the adhesive. It is possible here to make use of known systems such as doctor knives, rolls, nozzles, etc. The appropriate selection may be made without problems by a skilled person. Whereas in many cases the adhesive/coating technology combination results in sufficient penetration of the adhesive into the depressions in the woven fabric, and hence in effective anchorage of the layer of adhesive on the carrier, it is necessary, in those cases in which a layer of adhesive is drawn in the form of a film from the nozzle, for example, and merely placed, to ensure more intensive and durable contact between the two layers through additional use of pressure and temperature. This can be achieved by a subsequent pressure and pressing operation such as a calender station, for example. Alternatively, it can also be achieved by means of pretreatment of the carrier, by an additional primer coat, for example, which physically/chemically reinforces the adhesion and anchorage of the adhesive on the carrier.

### EXAMPLE E1

A black PET fabric in plain-weave construction, having a thread count of 31 cm⁻¹ in the warp, 22 cm⁻¹ in the weft, with 75 den yarn in the warp and 300 den yarn in the weft, and with a basis weight of 100 g/m², has an ultimate tensile strength in warp direction of 70 N/cm following continuous alkalizing in accordance with DE 10 2005 044 942 A1. Coated onto one side at 35 g/m² is a black-pigmented acrylate dispersion. The coating, which on account on its low T_{G} value is soft and tends toward blocking, is immediately then coated over with a transparent topcoat based on a hard acrylate dispersion, at 10 g/m², and is dried in such a way that the self-crosslinking topcoat is cured.

The tear propagation capacity and particularly the initial-tear capacity in weft direction from the edge are significantly improved by this coating. The carrier material is “hand tearable”.

The adhesive is prepared continuously in an extruder and applied at 80 g/m² to the carrier from the melt by means of nozzle coating. In place of the release coating, the adhesive is lined with siliconized release paper for the purpose of producing and investigating laboratory specimens.

Adhesive with formula as follows:

| | |
|---|---|
| 100 phr | IN FUSE 9107, |
| 78.4 phr | Ondina 933, |
| 212 phr | Foral 85 |
| 2 phr | Irganox 1076 |
| 5 phr | Tinuvin 111. |

The bond strength to steel is 9.8 N/cm. After one to two hours of peel increase, the woven-fabric tape can be removed from PE only with transfer of portions of the adhesive. In the UV test after 7 d and also in the SunTest after 2 weeks, slight visual changes are discernible, but the bonded adhesive tape exhibits virtually no indications of decomposition and detachment, and continues to adhere firmly and reliably.

### EXAMPLE E2

The carrier selected is a PE-extruded woven fabric. The carrier is completed with polyvinyl stearyl carbamate coating acquired from Japan. The carrier is a composite carrier having a thickness of 0.18 mm, composed of a 55 mesh VIS/PET blend fabric (30×25 inch⁻²) with a 65 g/m², black-colored LDPE coating bonded firmly to it.

Preparation and coating of the adhesive take place as in example E1, with the following formula:

| | |
|---|---|
| 100 phr | IN FUSE 9507, |
| 140 phr | Oppanol B10, |
| 250 phr | Regalite R1100 |
| 2 phr | Irganox 1076 |
| 5 phr | Tinuvin 111. |

The bond strength to steel is 9.0 N/cm for a coat weight of 70 g/m². Peel increase, UV tests, and weathering tests are examined and implemented as described for example E1, with a trend toward slight damage to the carrier being discernible. Here, a somewhat greater UV stabilization of the PE film is sensible, and can be implemented without problems for a skilled person. The adhesive itself exhibits no indications of damage.

### COUNTER EXAMPLE E1

Counter example E1 corresponds to a commercial woven-fabric tape made from viscose staple with a standard natural-rubber adhesive.

A 150 mesh viscose staple fabric (approximately 110 g/m² untreated fabric; symmetrical plain-weave construction with Nm 50 yarns in warp and weft) with a top-face pigmented acrylate coating (60 g/m²) and reverse-face natural-rubber coating (110 g/m²; no special UV stabilization) can be torn into easily, and adheres well to a variety of substrates, but has severe deficiencies in the UV tests and weathering tests after just a short period of exposure. Especially in the Suntester, distinct detachment phenomenon from the substrate and instances of decomposition of the adhesive are discernible. Since the adhesive tape, on account of its composition, is readily attacked by microorganisms and destroyed, it is highly unsuitable for outdoor application.

### COUNTER EXAMPLE E2

Counter example E2 corresponds to a commercial duct tape with a standard natural-rubber adhesive.

A knitted 30 mesh PET/VIS fabric (20×10 inch⁻²) and a silver, 50 μm PE film constitute the carrier components, which are equipped with a total of 160 g/m² of a very soft and tacky formulation of a natural-rubber adhesive, with about 5 to 10 g/m² functioning as a laminating adhesive.

The duct tape adheres well to a variety of substrates (for example, to steel 5 N/cm, to PE 2.5 N/cm); after 1 to 2 weeks of outdoor weathering, the first massive decomposition phenomena occur, and after 2 months the carrier has undergone almost complete delamination and the adhesive has hardened over, and so no longer has any self-adhesive properties. In the UV tests and weathering tests, these effects appear correspondingly earlier, after just short test durations: first severe creasing, then partial detachment of the PE film from the fabric, and only low remaining composite strength. Duct tapes of this kind are unsuitable for longer-lasting outdoor applications.

The adhesive tape of the invention is suitable additionally with very particular advantage on rough or contaminated substrates in the construction industry, specifically when, in accordance with a further advantageous embodiment of the invention, the adhesive tape comprises a carrier and an adhesive, the adhesive being coated from the melt on at least one side of said carrier and comprising an ethylene polymer having a density of between 0.86 and 0.89 g/cm³ and a crystallite melting point of at least 105° C., and comprising a tackifier resin.

In house building, adhesive tapes find diverse applications, for example, as sealing tape for joints, as plaster tape or assembly tape for bonding wind seals, vapor diffusion retarders, and vapor barriers.

The job of sealing tapes for joints is to give the joints immediately an airtight and optimum seal. These sealing tapes take the form preferably of self-adhesive tapes and, after the construction elements have been assembled on the inside of the wall, are adhered to the edges of the joint, spanning the joint. Plaster tape is used as an external cover for protecting profiles, door frames, window frames, and window sills. It is particularly suitable when applying and rubbing down plaster. The adhesive tape protects sensitive substrates, including stainless steel and anodized metals, from mechanical exposure and contamination. Assembly tapes for wind seals, vapor diffusion retarders, and vapor barriers are used in the fitting-out of houses, following the attachment of heat insulation materials and walls, roofs, and the like, in order to bond the film-form wind seals, vapor diffusion retarders and vapor barriers. For attachment to a wide variety of substrates, and also for bonding the resultant overlap points of the corresponding vapor diffusion retarders, vapor barriers, and wind seals, single-sidedly or double-sidedly adhesive assembly tapes are used.

All of the adhesive tapes used in the construction sector are subject to exacting requirements in relation to their resistance toward chemicals and water, adhesive bonding capacity, particularly at temperatures down to 0° C. as well, aging resistance, and sealing capacity. Common to all the applications is that the adhesive bond is to adhere reliably to contaminated and/or rough substrates such as, for example, concrete surfaces or wooden planks. Requirements relating in particular to assembly tapes for the bonding of wind seals are aging resistance and good adhesive properties on PE film.

DE 103 12 13 A1 describes a sealing tape for joints with an adhesive based on acrylate. Particular requirements which are cited include the capacity for processing at low temperatures, and also aging resistance.

Plaster tapes available commercially typically comprise a rubber adhesive. Since these adhesive tapes are often used to attach nonpolar protective films, nonpolar adhesives offer advantages here. Rubber adhesives, though, are limited in terms of their aging resistance. They ought therefore to be removed again in the outdoor area after no longer than six weeks.

A single-sidedly adhesive assembly tape for the bonding of wind seals, vapor diffusion retarders and vapor barriers is described in DE 297 23 454 U1. The assembly tape is composed of a film and an acrylate adhesive with a high coat weight of more than 80 g/m². In practice, adhesive tapes with coat weights of approximately 200 g/m² are offered. Since these high coat weights must be obtained after the drying of a solution of an acrylate adhesive, the production of an adhesive tape of this kind takes a very long time and is therefore expensive. For the bonding of wind seals, moreover, the manufacturer often guarantees an aging resistance of at least five years, and hence using an aging-resistant adhesive is very important. Consequently, it is not possible to consider using a solventlessly preparable rubber adhesive.

This adhesive tape can be produced solventlessly and is aging-stable, and can be used on rough or contaminated substrates in the construction industry.

If a plasticizer is not used, the tackifier resin preferably has a melting point of below 90° C.

Tackifier resins which have proven to be well suitable are resins based on rosin (for example, balsam resin) or on rosin derivatives (for example, disproportionated, dimerized or esterified rosin), preferably in partially or completely hydrogenated form.

It is preferred to use a primary antioxidant and more preferably a secondary antioxidant as well, in the quantities stated.

The preparation and processing of the pressure-sensitive adhesives may take place from solution and also from the melt. The advantage of processing the pressure-sensitive adhesive from the melt lies in the possibility of being able to achieve very high coat thicknesses (coat weights) within a very short time, since after the coating operation there is no solvent requiring removal. Preferred preparation and processing techniques are therefore from the melt. For the latter case, suitable production operations include not only batch processes but also continuous processes. Particular preference is given to the continuous manufacture of the pressure-sensitive adhesive by means of an extruder and subsequent coating directly onto the target substrate or onto a release paper or release film, with the adhesive at an appropriately high temperature. Preferred coating processes are extrusion coating with slot dies, and calender coating.

The coat weight (coating thickness) depending on application is between 10 and 300 g/m², more preferably between 20 and 250 g/m². For plaster tape applications, the coat weight tends to be within the lower range of these values; sealing tapes for joints and assembly tapes for wind seals, vapor diffusion retarders and vapor barriers generally have coat weights of between 50 and 250 g/m².

As carrier material it is possible to use polymeric films such as, for example, films made of polyolefin such as polyethylene, polypropylene, polybutene, their copolymers, blends of these polymers, for example, with polyethylene-vinyl acetate, or ionomers, and also films made of polyvinyl chloride or polyester. Stretchable film can be strengthened with a reinforcement, preferably a filament scrim. Also possible is the use of paper-plastic composites, obtained for example by extrusion coating or laminating. Depending on application, textile materials in open-pore form or as a textile/plastic composite may be used as carrier material. The plastics used may comprise flame retardants such as, for example, antimony trioxide or bromine-containing flame retardants such as Saytex® 8010, for example. The carrier material may have thicknesses of between 30 and 150 μm, preferably between 50 and 100 μm.

On the coating side, the surfaces of the carriers may be pretreated chemically or physically (corona, for example) and their reverse face may be subjected to an antiadhesive physical treatment or coating.

For use as a pressure-sensitive adhesive tape, the single- or double-sided pressure-sensitive adhesive tapes may be lined with one or two release films or release papers. One preferred version uses siliconized or fluorinated films or papers, such as glassine, HPDE or LDPE coated papers, for example, which in turn are given a release coat based on silicones or fluorinated polymers.

This embodiment of the adhesive tape is suitable for use as an aging-stable adhesive tape particularly for bonding on rough substrates such as concrete, plaster, stone or wood and on nonpolar surfaces such as polyethylene film. It may be used, for example, as a sealing tape for joints, as a plaster tape or as a single- or double-sidedly bonding assembly tape for wind seals, vapor diffusion retarders or vapor barriers. On account of the aging resistance of the adhesive, preference is given to use as assembly tape for wind seals, vapor diffusion retarders or vapor barriers.

### EXAMPLE F1

The adhesive is composed of the following components:

| | |
|---|---|
| 100 phr | IN FUSE 9107, |
| 78.4 phr | Ondina 933, |
| 212 phr | PRO 10394, |
| 2 phr | Irganox 1726. |

The adhesive is prepared continuously in an extruder and is applied from the melt at 30 g/m² to the carrier by means of nozzle coating. The carrier is a film made from 100 parts by weight of PVC (K value 65), 45 parts by weight of polymer plasticizer (Palamoll 652), 15 parts by weight of filler (chalk), 0.2 part by weight of lubricant (stearic acid), 5 parts by weight of pigment (titanium dioxide), and 3 parts by weight of stabilizer (calcium-zinc type), with a coating of a silicone-PMMA copolymer on the reverse face.

The bond strength to steel is 8.1 N/cm. The adhesive tape can be bonded to masonry even at 10° C.

### EXAMPLE F2

Adhesive as in example F1, but with the following formula:

| | |
|---|---|
| 100 phr | IN FUSE 9507, |
| 78.4 phr | Ondina 933, |
| 212 phr | Escorez 1310, |
| 2 phr | Irganox 1076. |

The adhesive is prepared continuously in an extruder and applied from the melt at 200 g/m² to a release paper by means of nozzle coating. The carrier film is 70 μm thick and is composed of 91.3% (w/w) of Novolen 2309 L block copolymer (BASF, melt index 6 g/10 min at 230° C. and 2.16 kg, ethylene content approximately 6.5% (w/w)), 8.4% (w/w) of titanium dioxide, and 0.3% (w/w) of the HALS stabilizer Tinuvin 770. It is corona-treated on one side prior to coating. Application of adhesive takes place to the corona-treated side of the carrier material, by lamination from coated release paper. The adhesive tape is wound to jumbos without removal of the release paper.

The bond strength to steel is 14.2 N/cm. The bond strength to polyethylene is 7.9 N/cm. After aging, the bond strength to polyethylene is still 90% of the original bond strength. The adhesive tape can be bonded to masonry, unsanded sawn wood, polyethylene film or polyamide film even at 0° C.

### EXAMPLE F3

Adhesive as in example F1, but with the following formula:

| | |
|---|---|
| 100 phr | IN FUSE 9107, |
| 78.4 phr | Ondina 933, |
| 212 phr | Foral 85, |
| 2 phr | Irganox 1076 |
| 5 phr | Tinuvin 111. |

The adhesive is coated as in example F2. The adhesive tape is produced analogously, but both sides of the carrier are corona-treated and coated with the adhesive. After the second transfer coating, the second release paper is removed and the adhesive tape is wound into jumbos.

The bond strength to steel is 16.9 N/cm. The bond strength to polyethylene is 10.5 N/cm. After aging, the bond strength to polyethylene is still 97% of the original bond strength. The adhesive tape can be bonded to masonry, unsanded sawn wood, polyethylene film or polyamide film even at 0° C.

### EXAMPLE F4

Adhesive as in example F1, but with the following formula:

| | |
|---|---|
| 100 phr | IN FUSE 9107, |
| 78.4 phr | Ondina 933, |
| 212 phr | Regalite R1100 |
| 2 phr | Irganox 1076. |

The adhesive is coated as in example F2 and, without removal of the release paper, is wound into jumbos. Application takes place in the form of a carrier-less, double-sidedly adhesive transfer tape, for example, for attaching wind seals, vapor diffusion retarders, and vapor barriers to unsanded sawn wood.

The bond strength to steel is 15.0 N/cm. The bond strength to polyethylene is 8.1 N/cm. After aging, the bond strength to polyethylene is still 96% of the original bond strength. The adhesive tape can be bonded to masonry, unsanded sawn wood, polyethylene film or polyamide film even at 0° C.

### EXAMPLE F5

Adhesive as in example F1, but with the following formula:

| | |
|---|---|
| 100 phr | IN FUSE 9107, |
| 78.4 phr | Ondina 933, |
| 212 phr | Regalite R1100 |
| 2 phr | Irganox 1076. |

The adhesive is coated as in example F2, but with a coat weight of only 70 g/m². Without removal of the release paper, the adhesive is wound into jumbos.

The bond strength to steel is 9.4 N/cm. The bond strength to polyethylene is 5.3 N/cm. After aging, the bond strength to polyethylene is still 95% of the original bond strength.

The adhesive tape can be bonded to masonry, unsanded sawn wood, polyethylene film or polyamide film even at 0° C.

### EXAMPLE F6

Adhesive as in example F1, but with the following formula:

| | |
|---|---|
| 100 phr | IN FUSE 9107, |
| 78.4 phr | Ondina 933, |
| 212 phr | Wingtack extra, |
| 2 phr | Irganox 1076. |

The adhesive is prepared continuously in an extruder and applied from the melt at 200 g/m² to a release paper by means of nozzle coating. The carrier material possesses a thickness of 100 μm and is composed of polyethylene-coated kraft paper (20 g/m² polyethylene). Application of the adhesive takes place onto the side of the kraft paper carrier material, by lamination from coated release paper. Without removal of the release paper, the adhesive tape is wound into jumbos.

Bond strength to steel is 16.3 N/cm. The bond strength to polyethylene is 10.1 N/cm. After aging, the bond strength to polyethylene is still 92% of the original bond strength. The adhesive tape can be bonded to masonry, unsanded sawn wood, polyethylene film or polyamide film even at 0° C.

### EXAMPLE F7

Adhesive as in example F1, but with the following formula:

| | |
|---|---|
| 100 phr | IN FUSE 9107, |
| 78.4 phr | Wingtack 10 |
| 212 phr | Wingtack extra |
| 2 phr | Irganox 1076. |

The adhesive is coated as in example F2 and the adhesive tape is produced in the same way.

Bond strength to steel is 5.3 N/cm. The bond strength to polyethylene is 3.6 N/cm. After aging, the bond strength to polyethylene is still 89% of the original bond strength. The adhesive tape can be bonded to masonry, unsanded sawn wood, polyethylene film or polyamide film even at 0° C.

### COMPARATIVE EXAMPLE F1

Implementation takes place as described in example F1, but the composition, in accordance with standard commercial formulas, is composed of

| | |
|---|---|
| 100 phr | Vector 4113, |
| 97 phr | Escorez 1310, |
| 21 phr | Ondina 933 and |
| 1 phr | Irganox 1726. |

The bond strength to polyethylene is 8.1 N/cm. After aging, the bond strength to polyethylene is still 74% of the original bond strength, corresponding to a marked drop in bond strength and to severe aging.

### COMPARATIVE EXAMPLE F2

Implementation takes place as in example F1; the adhesive is composed of the following components:

| | |
|---|---|
| 100 phr | IN FUSE 9107 |
| 78.4 phr | PB 0300 M |
| 212 phr | Escorez 5400 |
| 8 phr | Irganox 1076. |

The adhesive has virtually no tack.

### COMPARATIVE EXAMPLE F3

The adhesive used is an aqueous acrylate dispersion from the company Rohm and Haas, with the designation Primal PS83D (solids content 53% by weight; ammonia content <0.2% by weight; pH 9.1 to 9.8).

The release film is coated with the adhesive using a wire doctor. The wire doctor and the coating rate are set such that, after the coated film has dried, a coat weight of approximately 100 g/m² is measured. Coating rate and drier output are set such that the water content measured in the adhesive after drying is from 0.03% to 0.13% by weight. The film described in example F2 is corona-treated on one side. Application of the adhesive takes place to the corona-treated side by lamination from coated release paper. Following the first application of a coat thickness of 100 g/m², the release paper is removed and a second layer of adhesive is laminated onto the first layer, giving a coat weight of approximately 200 g/m².

The difficulty of drying the acrylate dispersion necessitates increased operational outlay, since producing a layer thickness of 200 g/m² in one operation results in uneconomically long drying times for the coating. When the adhesive is exposed to water, it swells and loses strength and adhesive power.

The adhesive tape of the invention is additionally suitable with very particular advantage as a roll plaster or individual plaster, as a diecut for bonding colostomy bags or electrodes, as an active compound patch, as a wound covering, as an orthopedic or phlebological bandage, or as an incision film, especially if, in accordance with one further advantageous embodiment of the invention, the adhesive tape comprises a carrier and an adhesive which is coated on at least one side of said carrier and comprises an olefin polymer having a density of between 0.86 and 0.89 g/cm² and a crystallite melting point of at least 105° C., and comprises a tackifier resin.

Strongly adhering orthopedic bandages and other medical products are typically coated over the whole of their area with a zinc rubber adhesive. The bonding of such products on the skin, after they have been removed, shows distinct skin irritation and mechanical stressing of the skin. Without auxiliary means, the bond can only be parted painfully. In some cases there are allergic reactions.

The adhesives used, furthermore, often lead to a transfer of adhesive to the skin.

It is not worth considering the use of skin-friendly adhesives such as acrylate adhesives, owing to their low shear stability and tack. Improvement through aftertreatment, more particularly crosslinking, is possible, although the result overall remains unsatisfactory. Moreover, in the case of circularly applied dressings with a plurality of plies, the bond strength to the reverse of the carrier in such systems is insufficient for a stable functional dressing. The proprioceptive effect is less than that of the systems comprising a zinc rubber adhesive.

Other known adhesive systems based on conventional block copolymers are, to start with, not skin-friendly, owing to the high level of addition of stabilizer, or because of the high cohesiveness have been found suitable to date only for industrial applications, and, secondly, cannot be formulated for strong adhesion and sticking to the skin.

In the case of partial coating, the limitations on possible coat weight mean that the bond strength is too low, particularly in the case of heavy carrier materials.

The abovementioned adhesives are pressure-sensitive self-adhesive compositions, and for processing may be present in a carrier matrix. Carrier matrices are understood to be common organic or inorganic solvents or dispersion media.

Systems without a carrier matrix are termed 100% systems and are likewise not unknown. They are processed in the thermoplastic state. One common mode of processing is the melt.

Pressure-sensitive hotmelt adhesives of this kind have also already been described in the prior art. They are based on natural or synthetic rubbers and/or on other synthetic polymers. On account of their high hardness, skin adhesion for such 100% systems is problematic.

It is additionally known to apply such self-adhesive compositions not only over the entire area but also in the form of a pattern of dots, for example, by screen printing (DE 42 37 252 C1), in which case the dots of adhesive may also differ in their size and/or distribution (EP 0 353 972 B1), or by means of gravure printing of lines which interconnect in the longitudinal and transverse directions (DE 43 08 649 C1). The advantage of the patterned application is found to be that the adhesive materials, given an appropriately porous carrier material, are permeable to air and water vapor and also, in general, are readily redetachable.

A disadvantage of these products, however, is that if the area covered by the adhesive layer, which is impermeable per se, is too large there is a corresponding reduction in the air and water vapor permeability, and the consumption of adhesive rises, and, if the area covered by the adhesive layer is small, the adhesion properties suffer, i.e., the product parts too readily from the substrate, especially in the case of heavy, textile carrier materials.

Medical products, such as an orthopedic dressing for example, are subject to exacting requirements with regard to the adhesive properties. For an ideal application, the self-adhesive composition ought to possess a high tack. There should be functionally appropriate bond strength to the skin and to the reverse of the carrier. Moreover, so that there is no slipping of the plies, the self-adhesive composition is required to have a high shear strength.

The adhesives of the invention exhibit outstanding adhesive properties on skin.

Tackifier resins which have proven highly suitable are resins based on rosin (for example, balsam resin) or on rosin derivatives (for example, disproportionated, dimerized or esterified rosin), preferably in partially or completely hydrogenated form.

Advantageous more particularly for use in the case of medical products is if the pressure-sensitive hotmelt adhesive has been applied partially to the carrier material, by means of halftone printing, thermal screen printing or gravure printing, since carrier materials which have been self-adhesively treated in a continuous applied line may, on application, induce mechanical irritations of the skin.

The partial application makes it possible to remove the transepidermal water loss through controlled channels, and improves the removal of sweat from the skin in vapor form, especially when the carrier materials used are permeable to air and to water vapor. By this means, skin irritations such as macerations, induced by accumulations of body fluids, are prevented. The removal channels set up enable fluids to be conducted away even when a multi-ply dressing is used.

Preference is given to application in the form of polygeometric domes, and especially of domes for which the ratio of diameter to height is less than 5:1. Also possible, furthermore, is the printed application of other shapes and patterns on the carrier material, as for example a printed image in the form of alphanumeric character combinations or patterns such as grids, stripes and zigzag lines.

Furthermore, for example, it may also be applied by spraying, producing a more or less irregular applied image.

The adhesive may be distributed uniformly on the carrier material, but may also be applied with different thicknesses or densities over the area, in a manner appropriate to the function of the product.

A self-adhesive hotmelt may be applied by thermal screen printing. The principle of thermal screen printing lies in the use of a rotating, heated, seamless, drum-shaped, perforated, cylindrical screen which is fed via a nozzle with the pressure-sensitive hotmelt. A specially shaped nozzle lip (circular or rectangular bar) presses the self-adhesive composition, which is fed in via a channel, through the perforations in the screen wall and onto the carrier web that is conveyed past it. This web is guided by means of a backing roll against the external jacket of the heated screen drum, at a rate which corresponds to the peripheral speed of the rotating screen drum.

In this operation, the small domes of adhesive are formed in accordance with the following mechanism:

The pressure of the nozzle bar conveys the self-adhesive composition through the screen perforations and onto the carrier material. The size of the domes formed is determined by the diameter of the screen perforation. The screen is lifted from the carrier in accordance with the rate of transportation of the carrier web (rotational speed of the screen drum). As a consequence of the high adhesion of the self-adhesive composition and the internal cohesion of the hotmelt, the limited supply of pressure-sensitive hotmelt in the perforations is drawn in sharp definition from the base of the domes that is already adhering to the carrier, and is conveyed by the pressure of the bar onto the carrier.

After the end of this transportation, the more or less highly curved surface of the dome is formed over the predetermined base area, in dependence on the rheology of the pressure-sensitive hotmelt. The height-to-base ratio of the dome depends on the ratio of perforation diameter to wall thickness of the screen drum and on the physical properties (flow behavior, surface tension, and contact angle on the carrier material) of the self-adhesive composition.

In the case of the screen stencil in thermal screen printing, the web-to-hole ratio may be less than 2:1, preferably less than or equal to 1:1.

The above-described mechanism of dome formation preferentially requires carrier materials that are absorbent or at least wettable by pressure-sensitive hotmelt. Non-wetting carrier surfaces must be pretreated by chemical physical techniques. This can be accomplished by additional measures such as, for example, corona discharge or coating with substances that enhance wetting.

Using the printing technique indicated it is possible to lay down the size and shape of the domes in a defined manner. The bond strength values which are relevant for the application and which determine the quality of the products produced are situated, in the case of proper coating, within very narrow tolerances. The base diameter of the domes can be chosen to be from 10 μm to 5000 μm, the height of the domes from 20 μm to approximately 2000 μm, preferably 50 μm to 1000 μm, with the low-diameter range being envisaged for smooth carriers, and the range of greater diameter and greater dome height being envisaged for rough or highly porous carrier materials.

The positioning of the domes on the carrier is laid down in a defined manner by the geometry of the applicator unit, for example, the gravure or screen geometry, which can be varied within wide limits. With the aid of the parameters indicated it is possible, via adjustable variables, to set with very high precision the desired profile of properties of the coating, tailored to the various carrier materials and applications.

The carrier is coated preferably at a rate of more than 2 m/min, preferably 20 to 100 m/min, the coating temperature chosen being greater than the softening temperature.

The percent fraction of the area that is coated with the pressure-sensitive hotmelt ought—as already mentioned—to be at least 20% and may be up to 95%, for specialty products preferably 40% to 60% and also 70% to 95%. This may be achieved, where appropriate, by multiple application, in which case it is also possible, if desired, to use adhesives having different properties.

In accordance with one advantageous embodiment of the invention, the adhesive tape has a bond strength to the reverse of the carrier of at least 1.5 N/cm, especially a bond strength of between 2.5 N/cm and 5 N/cm. On other substrates, higher bond strengths may be achieved.

The combination of the self-adhesive composition and the partial coating on the one hand ensures reliable bonding of—in particular—the medical product on the skin, while on the other hand, allergic or mechanical skin irritation, at least that which is perceptible visually, is ruled out, even in the case of use extending over several days.

The epilation of corresponding body regions and the transfer of composition to the skin are negligible, owing to the high cohesiveness of the adhesive, because the adhesive does not anchor itself to skin and hair; instead, the anchorage of the adhesive to the carrier material, at up to 12 N/cm (sample width), is very good, especially for medical applications.

As a result of the intended breakage points that have been formed in the coating, layers of skin are no longer displaced with one another or against one another during detachment. The absence of displacement of the skin layers, and the relatively low level of epilation, result in an unprecedented degree of painlessness for such strongly adhering systems. Furthermore, the individual biomechanical control of bond strength, which exhibits a demonstrable reduction in the bond strength of the adhesive tape, assists detachability. The applied dressing shows good proprioceptive effects.

Depending on carrier material and its temperature sensitivity, the self-adhesive may be applied directly or may first be applied to an auxiliary carrier and then transferred to the ultimate carrier.

Suitable carrier materials include all rigid and elastic sheetlike structures made from synthetic and natural raw materials. Preference is giving to those carrier materials which, following application of the adhesive, can be used in such a way that they fulfill the properties of a functionally appropriate dressing. Cited by way of example are textiles such as wovens, knits, scrims, nonwovens, laminates, nets, films, foams, and papers.

The adhesive tape may have an air permeability of greater than 1 cm³/(cm²*s), preferably greater than 15 cm³/(cm²*s), very preferably greater than 70 cm³/(cm²*s), and also may have a water vapor permeability of greater than 500 g/(m²*24 h), preferably greater than 1000 g/(m²*24 h), very preferably greater than 2000 g/(m²*24 h).

In the assembly of plies, the adhesive tape, moreover, may also have an air permeability of 1 g/(m²*24 h) and a water vapor permeability of 500 g/(m²*24 h).

Finally, following application, the adhesive tape may be enveloped or may be provided with a wound pad and/or cushioning.

A particular advantage is that the adhesive tape can be sterilized, more particularly by means of radiation, since the polymer of the adhesive does not contain double bonds with a propensity to crosslink.

Furthermore, on the side opposite the side coated with the adhesive, the carrier may be treated with a water-repelling layer or impregnation system which prevents rapid soaking on contact with water or perspiration. In addition to the known impregnation systems, this may also be accomplished by the stitched attachment of a film, advantageously a water vapor permeable film.

The carrier may additionally be equipped with a release layer or release impregnation and/or coating system that reduces the bond strength of the adhesive. Here as well it is possible, besides the known release materials, to use a film, advantageously a water vapor permeable film.

The adhesive tape of the invention is outstandingly suitable for applications on human skin. Examples are roll plasters and individual plasters, diecuts for the bonding of colostomy bags and electrodes, active compound patches (transdermal patches), wound covers, and orthopedic or phlebological bandages, and incision films. This suitability is given as a result of the adhesive properties, but also the possibility of avoiding skin-irritating substances, or substances with another chemical action, such as antioxidants. The adhesive of the invention exhibits an outstanding balance between adhesion to the skin and ease of detachment from the skin after use without skin irritations.

### EXAMPLE G1

The adhesive is composed of the following components:

| | |
|---|---|
| 100 phr | IN FUSE 9107, |
| 78.4 phr | Ondina 933, |
| 212 phr | Wingtack extra |

The adhesive is prepared continuously in an extruder and applied from the melt to the carrier at 70 g/m² by means of nozzle coating. The carrier is a skin-color film of polyethylene and propropylene which on the underside (coating side) is laminated with a polypropylene web. The adhesive, following application to the carrier, is provided with wound covering material and lined with a silicone paper liner. Individual plasters with air holes are diecut from this material. The bond strength to steel is 9 N/cm. The adhesive tape (plaster) showed reversible detachment from the skin and also good air and water vapor permeability. No instances of skin irritation are observed, and the epilation observed following removal of the plaster is negligibly small.

### EXAMPLE G2

Implementation takes place as described in example G1, but with the following formula:

| | |
|---|---|
| 100 phr | NOTIO PN-0040, |
| 78.4 phr | Wingtack 10, |
| 212 phr | Escorez 1310 and |
| 1 phr | Irganox 1076. |

It is applied by hotmelt screen printing (screen thickness 300 mesh count 25) to a woven cotton fabric (ultimate tensile strength 60 N/cm, elongation at break 10%). The coat weight is 120 g/m². The bond strength to steel is 11 N/cm. The adhesive tape (bandage) showed reversible detachment from the skin and also good air and water vapor permeability. No instances of skin irritation are observed, and the epilation observed following removal of the plaster is negligibly small.

### EXAMPLE G3

Implementation takes place as described in example G1, but with the following formula:

| | |
|---|---|
| 100 phr | Softell CA02, |
| 50 phr | Ondina 933, |
| 212 phr | Regalite R1100 and |
| 20 phr | Salicylic acid. |

The adhesive is applied at 70 g/m² to a woven cellulose acetate fabric. It is suitable as a wart plaster.

### COMPARATIVE EXAMPLE G1

Implementation takes place as described in example G1, but with LD251 instead of IN FUSE 9107. The coating, rather than being tacky, is hard, with an oily surface.

1. An adhesive tape comprising a carrier and an adhesive, wherein the adhesive is coated at least on one side of the carrier and comprises an olefin polymer, having a density of between 0.86 and 0.89 g/cm³ and a crystallite melting point of at least 105° C., and a tackifier resin.

2. The adhesive tape according to claim 1, wherein the density of the olefin polymer is between 0.86 and 0.88 g/cm³, and/or the olefin polymer has a crystallite melting point of at least 105° C.

3. The adhesive tape according to claim 1, wherein the olefin polymer has a melt index of less than 8 g/10 min, and/or a flexural modulus of less than 50 MPa.

4. The adhesive tape according to claim 1, wherein the olefin polymer comprises ethylene or propylene and at least one further comonomer selected from the C₂ to C₁₀ olefins.

5. The adhesive tape according to claim 1, wherein the olefin polymer is a block copolymer, a graft polymer or a heterophasic polymer based on polypropylene.

6. The adhesive tape according to claim 1, wherein the adhesive comprises a tackifier resin having a polydispersity of less than 2.1.

7. The adhesive tape according to claim 1, wherein the tackifier resin is selected from the group consisting of
resins based on rosin or rosin derivatives, partially or completely hydrogenated,
hydrocarbon resins based on C₅ monomers, partially or completely hydrogenated,
hydrocarbon resins from hydrogenation of aromatics-containing hydrocarbon resins,
hydrocarbon resins based on hydrogenated cyclopentadiene polymers,
resins based on polyterpenes, partially or completely hydrogenated, and
terpene-phenolic resins,
wherein an amount of tackifier resin in the adhesive is from 130 to 350 phr.

8. The adhesive tape according to claim 1, wherein the adhesive comprises a plasticizer selected from the group consisting of mineral oils, liquid polymers of isobutene homopolymer and isobutene-butene copolymer.

9. The adhesive tape according to claim 1, wherein the adhesive comprises a copolymer or terpolymer of ethylene, propylene, but-1-ene, hex-1-ene and/or oct-1-ene, wherein a flexural modulus of the copolymer or terpolymer is below 10 MPa and a crystallite melting point of the copolymer or terpolymer is below 50° C., or comprises an EPM or EPDM, having an ethylene content of 40% to 70% by weight and/or a density below 0.88 g/cm³, wherein an amount of copolymer or terpolymer present in the adhesive is above 100 phr.

10. The adhesive tape according to claim 1, wherein the adhesive comprises
i. a primary antioxidant, in an amount of at least 2 phr and/or with a sterically hindered phenolic group,
ii. a secondary antioxidant in an amount of 0 to 5 phr and/or from the class of the sulfur compounds or from the class of the phosphites,
iii. a light stabilizer and/or
iv. a UV absorber.

11. The adhesive tape according to claim 1, wherein the adhesive is substantially mineral oil-free and/or comprises a mineral oil-free plasticizer.

12. The adhesive tape according to claim 1, wherein the adhesive is applied onto the carrier at an amount from 10 to 300 g/m².

13. A method for bonding colostomy bags or electrodes, the method comprising:
bonding said colostomy bags or said electrodes with a roll plaster diecut or an individual plaster diecut, as an active-substance patch, a wound covering or orthopedic or a phlebological bandage, or an incision film, wherein the roll plaster diecut or the individual plaster diecut comprises the adhesive tape according to claim 1.

14. A method for reinforcing cardboard packaging, securing a pallet, and sealing of folding cartons, the method comprising:
reinforcing said cardboard packaging with the adhesive tape according to claim 1, wherein the adhesive tape is tear-open strip or a carry handle;
securing said pallet with the adhesive tape according to claim 1; or
sealing said folding cartons with the adhesive tape according to claim 1.

15. The method according to claim 14, wherein the adhesive is applied solventlessly onto the carrier.

16. The method according to claim 14, wherein the olefin polymer is an ethylene polymer.

17. A method for bundling, protecting, labeling, insulating or sealing ventilation pipes, wires or cables, the method comprising:
wrapping said ventilation pipes, said wires or said cables with a winding tape comprising the adhesive tape according to claim 1.

18. The method according to claim 17, wherein the carrier comprises
a primary antioxidant, in an amount of at least 2 phr, and/or
a secondary antioxidant in an amount of 0 to 5 phr.

19. A method for bandaging cable, the method comprising:
bandaging the cable with the adhesive tape according to claim 1.

20. The method according to claim 19, wherein the adhesive is applied solventlessly onto the carrier.

21. The method according to claim 19, wherein the olefin polymer is an ethylene polymer.

22. The method according to claim 19, wherein the carrier is a textile carrier.

23. The adhesive tape according to claim 1, wherein the carrier of the adhesive tape is a textile carrier having a basis weight of 15 to 150 g/m², wherein an additional layer is applied to a top face of the carrier by extrusion coating, by dispersion coating or by film lamination, wherein the adhesive is located on a bottom face of the carrier, wherein the olefin polymer is an ethylene polymer.

24. A method for sealing joints, the method comprising:
sealing said joints with an adhesive tape comprising a carrier and an adhesive, wherein the adhesive is coated from the melt on at least one side of the carrier, wherein the adhesive comprises an ethylene polymer, having a density of between 0.86 and 0.89 g/cm³ and a crystallite melting point of at least 105° C., and a tackifier resin.

25. A method for adhesively bonding wind seals, vapor diffusion retarders, or vapor barriers, the method comprising:
bonding said wind seals, said vapor diffusion retarder or said vapor barriers with a single- or double-sidedly adhesive assembly tape comprising a carrier and an adhesive, wherein the adhesive is coated from the melt on at least one side of the carrier, wherein the adhesive comprises an ethylene polymer, having a density of between 0.86 and 0.89 g/cm³ and a crystallite melting point of at least 105° C., and a tackifier resin.

26. (canceled)
